(19) United States
(12) Patent Application Publication
(10) Pub. No.: US 2026/0116106 A1
(43) Pub. Date: Apr. 30, 2026

(54) RECORDING APPARATUS AND WASTE LIQUID STORING BODY

(71) Applicant: SEIKO EPSON CORPORATION, Tokyo (JP)

(72) Inventors: Satoshi NAKATA, MATSUMOTO-SHI (JP); Masanari TANAKA, SHIOJIRI-SHI (JP); Kanji MOMOSE, MATSUMOTO-SHI (JP)

(21) Appl. No.: 19/369,725

(22) Filed: Oct. 27, 2025

(30) Foreign Application Priority Data
Oct. 29, 2024 (JP) 2024-189882

(51) Int. Cl. B41J 29/13; B41J 2/17; B41J 2/175

(52) U.S. Cl. CPC B41J 29/13; B41J 2/1721; B41J 2/175

(57) ABSTRACT

Waste liquid from a recording portion of a recording apparatus is stored in a waste liquid storing body. The recording apparatus includes a discharger that discharges the waste liquid, a loading portion into which the waste liquid storing body is loaded, and a displaceable protector. A region occupied by the waste liquid storing body at a first position is a first region, a region occupied by the waste liquid storing body at a the second position is a second region, and a region that does not overlap with the second region out of the first region is a third region. The protector is located at a protection position where the protector covers at least a portion of the third region when the waste liquid storing body is at the second position. The protector is retracted from the protection position when the waste liquid storing body is at the first position.

The present application is based on, and claims priority from JP Application Serial Number 2024-189882, filed Oct. 29, 2024, the disclosure of which is hereby incorporated by reference herein in its entirety.

### BACKGROUND

### 1. Technical Field

The present disclosure relates to a recording apparatus, such as a printer, and a waste liquid storing body.

### 2. Related Art

There is a recording apparatus that performs recording by ejecting ink that is an example of liquid from a recording head that is an example of a recording portion, as described, for example, in JP-A-2024-042592. The recording apparatus includes a storing portion that is an example of a loading portion, and a recovery portion. The storing portion houses a waste ink tank that is an example of a waste liquid storing body. The recovery portion performs a recovery operation of maintaining and recovering ink ejection performance. The recovery portion discharges waste ink received in the recovery operation into the waste ink tank.

JP-A-2024-042592 is an example of the related art.

The waste ink tank disclosed in JP-A-2024-042592 is inserted through an opening in the −Z direction and then moved in the Y direction to be stored in the storing portion. The storing portion therefore requires a space in which the waste ink tank is attached and detached. In a state in which the waste ink tank is stored, for example, when foreign matter falls into the space for the attachment and detachment, the foreign matter may hinder the detachment of the waste ink tank.

### SUMMARY

A recording apparatus according to an aspect of the present disclosure includes: a recording portion configured to perform recording by ejecting liquid onto a medium, waste liquid discharged from the recording portion being stored in a waste liquid storing body; a discharger inserted into an insertion port of the waste liquid storing body and configured to discharge the waste liquid into the waste liquid storing body; a loading portion into which the waste liquid storing body is loaded when the waste liquid storing body is displaced in a loading direction from a first position where the discharger is not inserted into the insertion port to a second position where the discharger is inserted into the insertion port; and a displaceable protector, a region occupied by the waste liquid storing body located at the first position is called a first region, a region occupied by the waste liquid storing body located at the second position is called a second region, a region that does not overlap with the second region out of the first region is called a third region, the protector is located at a protection position where the protector covers at least a portion of the third region when the waste liquid storing body is at the second position, and the protector is retracted from the protection position when the waste liquid storing body is at the first position.

A waste liquid storing body according to another aspect of the present disclosure is attachable to and detachable from a recording apparatus including a recording portion configured to perform recording by ejecting liquid onto a medium, the waste liquid storing body configured to store waste liquid discharged from the recording portion, and including: a main body at which an insertion port into which a discharger provided in the recording apparatus is inserted is formed, the main body configured to store the waste liquid; and a protector displaceable with respect to the main body, a region occupied by the waste liquid storing body located at a first position where the discharger is not inserted into the insertion port is called a first region, a region occupied by the waste liquid storing body located at a second position where the discharger is inserted into the insertion port is called a second region, a region that does not overlap with the second region out of the first region is called a third region, and when the waste liquid storing body is at the second position, the protector covers at least a portion of the third region.

A recording apparatus according to another aspect of the present disclosure is a recording apparatus to and from which the waste liquid storing body having the configuration described above is attachable and detachable and which includes: the recording portion configured to perform recording by ejecting liquid onto a medium; the discharger inserted into the insertion port of the waste liquid storing body and configured to discharge the waste liquid into the waste liquid storing body; and a loading portion into which the waste liquid storing body is loaded when the waste liquid storing body is displaced in a loading direction from the first position, where the discharger is not inserted into the insertion port, to the second position, where the discharger is inserted into the insertion port.

### BRIEF DESCRIPTION OF THE DRAWINGS

FIG. 1 is a perspective view of a first embodiment of a recording apparatus.

FIG. 2 is a diagrammatic cross-sectional view of the recording apparatus.

FIG. 3 is a perspective view of a first maintenance cover located at a non-cover position.

FIG. 4 is a cross-sectional view taken along the line F4-F4 in FIG. 3.

FIG. 5 is a perspective view of the first maintenance cover located at a cover position.

FIG. 6 is a plan view of an operation portion located at an unlocked position.

FIG. 7 is a plan view of the operation portion located at a locked position.

FIG. 8 is a cross-sectional view taken along the line F8-F8 in FIG. 5.

FIG. 9 is a partial perspective view of a second embodiment of the recording apparatus.

FIG. 10 is a perspective view of the first maintenance cover located at the cover position.

FIG. 11 is a plan view of the operation portion located at the unlocked position.

FIG. 12 is a plan view of the operation portion located at the locked position.

FIG. 13 is a partial plan view of the first maintenance cover in which an engager hits an engagement receiver.

FIG. 14 is an enlarged view of a portion F14 in FIG. 10.

FIG. 15 is a partial plan view of a third embodiment of the recording apparatus.

FIG. 16 is a perspective view of the first maintenance cover in the state in which the operation portion is located at the unlocked position.

FIG. 17 is a perspective view of the first maintenance cover in the state in which the operation portion is at the locked position.

FIG. 18 is a perspective view of the first maintenance cover of the recording apparatus according to a fourth embodiment.

FIG. 19 is a perspective view of the first maintenance cover in the state in which the operation portion is located at the unlocked position.

FIG. 20 is a plan view of a waste liquid storing body loaded in the recording apparatus according to a fifth embodiment.

FIG. 21 is a cross-sectional view taken along the line F21-F21 in FIG. 20.

FIG. 22 is a plan view of the waste liquid storing body located at a first position.

FIG. 23 is a cross-sectional view taken along the line F23-F23 in FIG. 22.

FIG. 24 is a perspective view of the recording apparatus from which the waste liquid storing body is detached.

FIG. 25 is a perspective view of the waste liquid storing body in a sixth embodiment.

FIG. 26 is a perspective view of the recording apparatus according to the sixth embodiment.

FIG. 27 is a cross-sectional view of a loading portion in which the waste liquid storing body is located at the first position.

FIG. 28 is a cross-sectional view of the loading portion in which the waste liquid storing body is located at a second position.

FIG. 29 is a perspective view of the waste liquid storing body in a seventh embodiment.

FIG. 30 is a perspective view of the waste liquid storing body in which a protector is located at a stored position.

FIG. 31 is a cross-sectional view taken along the line F31-F31 in FIG. 30.

FIG. 32 is a plan view of the loading portion of the recording apparatus according to the seventh embodiment.

FIG. 33 is a plan view of the loading portion in which the waste liquid storing body is located at the first position.

FIG. 34 is a plan view of the loading portion in which the waste liquid storing body is located at an intermediate position.

FIG. 35 is a plan view of the loading portion in which the waste liquid storing body is located at the second position.

FIG. 36 is a perspective view of the waste liquid storing body in an eighth embodiment.

FIG. 37 is a perspective view of the loading portion in which the waste liquid storing body is located at the first position.

FIG. 38 is a perspective view of the loading portion in which the waste liquid storing body is located at the second position.

FIG. 39 is a cross-sectional view of the loading portion of the recording apparatus according to a ninth embodiment.

FIG. 40 is a cross-sectional view of the loading portion in which the waste liquid storing body is located at the second position.

### DESCRIPTION OF EMBODIMENTS

### First Embodiment

A first embodiment of a recording apparatus will be described below with reference to the drawings. The recording apparatus is, for example, an inkjet printer that ejects ink, which is an example of liquid, onto a medium such as a paper sheet, fabric, a vinyl sheet, a plastic part, and a metal part to perform recording.

In the drawings, a Z-axis represents the direction of gravity, and an X-axis and a Y-axis represent directions along a horizontal surface on the assumption that a recording apparatus 11 is placed on the horizontal surface. The X-axis, the Y-axis, and the Z-axis are orthogonal to each other. In the description below, a direction parallel to the X-axis is also referred to as a width direction X, a direction parallel to the Y-axis is also referred to as a depth direction Y, and a direction parallel to the Z-axis is also referred to as a vertical direction Z.

### Recording Apparatus

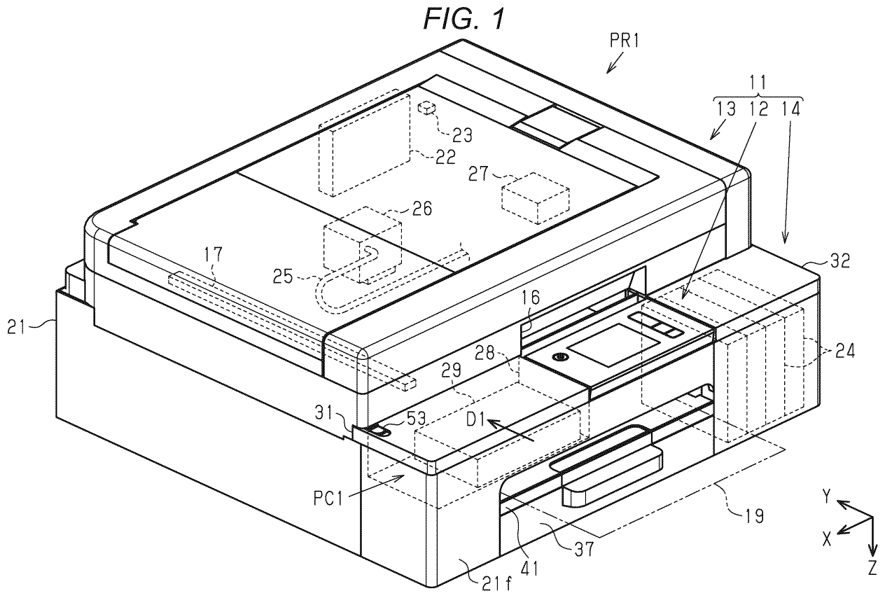

The recording apparatus 11 may include an operation panel 12, a reading unit 13, which is an example of a second cover, and a recording unit 14, as shown in FIG. 1. The reading unit 13 and the operation panel 12 may be provided above the recording unit 14.

### Operation Panel

It is intended that a user operates the recording apparatus 11 via the operation panel 12. The operation panel 12 is operated by the user. The operation panel 12 may include a monitor, buttons, a touch panel, and the like.

### Reading Unit

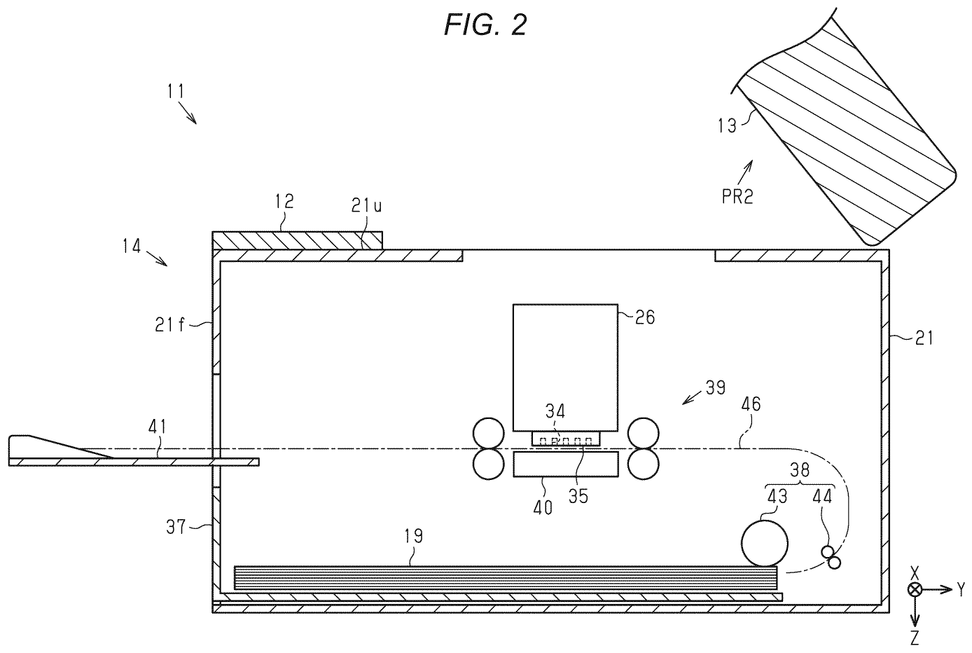

The reading unit 13 is configured to read an image of a document that is not shown. The reading unit 13 in the present embodiment is provided adjacent to the operation panel 12 at a position behind the operation panel 12 in the depth direction Y. The reading unit 13 may be rotatable around a hinge or a shaft that is not shown but is provided rearward in the depth direction Y. The reading unit 13 may be provided to be openable and closable with respect to the recording unit 14. The reading unit 13 may be so rotated that it is displaceable to a reading position PR1, which is an example of a second cover position shown FIG. 1, and a non-reading position PR2, which is an example of a second non-cover position shown in FIG. 2.

To read a document, for example, the user positions the reading unit 13 at the reading position PR1. To perform maintenance of the recording unit 14, for example, the user positions the reading unit 13 at the non-reading position PR2. The reading position PR1 is a position at which the interior of the apparatus is covered. The reading unit 13 located at the reading position PR1 extends along the recording unit 14 and covers a portion of the recording unit 14 from above. The non-reading position PR2 is a position at which the interior of the apparatus is not covered. The reading unit 13 located at the non-reading position PR2 uncovers the interior of the recording unit 14.

The reading unit 13 may include a handle 16 and a reader 17, as shown in FIG. 1.

The handle 16 may be a recess located at the front end of the reading unit 13. In the width direction X, the handle 16 may be approximately as large as the operation panel 12 or may be larger than the operation panel 12. The user can readily move the reading unit 13 located at the reading position PR1 to the non-reading position PR2 by putting his/her hand on the handle 16.

The reader 17 is configured to read an image of a document that is not shown. The reader 17 may be capable of reading a document when the reading unit 13 is located at the reading position PR1. The reader 17 may read a conveyed stationary document. The reader 17 may read a stationary document while moving. The reader 17 generates image data by reading a document.

### Recording unit

The recording unit 14 is configured to perform recording on a medium 19, as shown in FIG. 1. The recording unit 14 may include an enclosure 21, a controller 22, and a detector 23. The recording unit 14 may further include a liquid storing body 24, a supply channel 25, a recording portion 26, a maintenance portion 27, and a loading portion 28. A waste liquid storing body 29, which is an example of a loaded member, is loaded into the loading portion 28.

The recording unit 14 may include a first maintenance cover 31 and a second maintenance cover 32. The first maintenance cover 31 is an example of a cover and a first cover. The first maintenance cover 31 and the second maintenance cover 32 are so located that the two covers are separate from each other in the width direction X. The first maintenance cover 31 and the second maintenance cover 32 are provided adjacent to the operation panel 12 in a way that the two covers sandwich the operation panel 12 in the width direction X. In other words, the operation panel 12 is located between the first maintenance cover 31 and the second maintenance cover 32 in the width direction X.

The enclosure 21 houses various elements that constitute the recording unit 14. The enclosure 21 may have a front surface 21f and a first upper surface 21u, the latter of which is shown in FIG. 2. The front surface 21f is located forward in the depth direction Y. The first upper surface 21u is located upward in the vertical direction Z. The first upper surface 21u faces the operation panel 12.

The controller 22 harmoniously controls the operations of driving mechanisms in the recording unit 14 to control various operations performed by the recording unit 14. The controller 22 may harmoniously control the operations of driving mechanisms in the recording apparatus 11 to control various operations performed by the recording apparatus 11.

The controller 22 can be configured as a circuit including α: one or more processors that carry out various processes in accordance with a computer program, β: one or more dedicated hardware circuits that carry out at least some of the various processes, or γ: a combination of α and β. The hardware circuit is, for example, an application specific integrated circuit. The processor includes a CPU and a memory such as a RAM and a ROM, and the memory memorizes program codes or instructions configured to cause the CPU to carry out the processes. The memory, that is, a computer-readable medium includes any readable medium that can be accessed by a general-purpose or dedicated computer.

The detector 23 can detect whether the reading unit 13 is open or closed. The detector 23 may detect, for example, whether the reading unit 13 is located at the reading position PR1. The detector 23 is, for example, a contact sensor. The detector 23 is, for example, a photoelectric sensor including a light projector and a light receiver.

The liquid storing body 24 stores liquid to be supplied to the recording portion 26. The recording unit 14 may include one or more liquid storing bodies 24. The multiple liquid storing bodies 24 may be arranged in the width direction X. The multiple liquid storing bodies 24 may store different types of liquid. The different types of liquid are, for example, different types of ink having different colors. The liquid storing body 24 may be fixed to the recording unit 14. The liquid storing body 24 may be a refillable liquid storing body. The liquid storing body 24 may be a cartridge, a pack, or any other element that is configured separately from the recording unit 14 and is attachable to and detachable from the recording unit 14. That is, the recording unit 14 may not include the liquid storing body 24.

The second maintenance cover 32 is located above the one or more liquid storing bodies 24. The second maintenance cover 32 is openable and closable with respect to the enclosure 21. The second maintenance cover 32 may be opened or closed, for example, through rotation or sliding motion. The second maintenance cover 32 located at a closed position shown in FIG. 1 covers the liquid storing body 24. The second maintenance cover 32 located at an open position that is not shown exposes a portion of the liquid storing body 24. The second maintenance cover 32 located at the open position allows the liquid storing body 24 to be refilled with liquid or the liquid storing body 24 to be replaced with another.

The recording apparatus 11 may include one or more supply channels 25. The recording apparatus 11 may include supply channels 25 the number of which is equal to the number of the liquid storing bodies 24. The supply channel 25 may be configured with a deformable tube. The supply channel 25 can supply the recording portion 26 with liquid. The supply channel 25 has an upstream end coupled to the liquid storing body 24 and a downstream end coupled to the recording portion 26.

The recording portion 26 performs recording on the medium 19, as shown in FIG. 2. The recording portion 26 in the present embodiment is a liquid ejector capable of ejecting liquid. The recording portion 26 has a nozzle surface 35, at which one or more nozzles 34 open. The recording portion 26 ejects the liquid supplied from the liquid storing body 24 via the nozzle 34. The recording portion 26 performs recording by ejecting the liquid onto the medium 19. The recording portion 26 may be capable of making reciprocating movement in a scan direction. The scan direction may be a direction parallel to the X-axis.

The maintenance portion 27 performs maintenance of the recording portion 26, as shown in FIG. 1. Examples of the maintenance may include flushing, cleaning, and wiping. The maintenance portion 27 may forcibly discharge the liquid via the nozzle 34. The maintenance portion 27 suppresses deterioration of the liquid ejection performance of the nozzle 34 by causing the liquid having increased viscosity, foreign matter, air bubbles, or the like along with the original liquid to be discharged via the nozzle 34. The maintenance portion 27 collects the discharged liquid as waste liquid. The maintenance portion 27 sends the collected waste liquid to the waste liquid storing body 29.

The waste liquid storing body 29 can store the waste liquid discharged from the recording portion 26. The waste liquid storing body 29 stores the waste liquid collected by the maintenance portion 27. The waste liquid storing body 29 is attachable to and detachable from the recording apparatus 11.

The recording unit 14 may include a medium storing portion 37, a feeder 38, a conveyer 39, a support 40, and a discharge tray 41, as shown in FIG. 2.

The medium storing portion 37 can store multiple media 19 in a stacked manner.

The feeder 38 feeds the media 19 stored in the medium storing portion 37 one by one. The feeder 38 may include a feeding roller 43 and a separator 44. The feeding roller 43 rotates in a state in which the feeding roller 43 is in contact with the media 19 stored in the medium storing portion 37 to feed the media 19 to the separator 44. The separator 44 separates each of the fed multiple media 19 stacked on each other from the others.

The conveyer 39 conveys the medium 19 along a conveyance path 46 indicated by the one-dot chain line in FIG. 2. The conveyer 39 conveys the medium 19 fed by the feeder 38 to the discharge tray 41 located downstream in a conveyance direction. The conveyance direction is a direction along the conveyance path 46.

The support 40 supports the conveyed medium 19. The support 40 constitutes a portion of the conveyance path 46. The support 40 faces the recording portion 26 across the conveyance path 46.

The discharge tray 41 receives a recorded medium 19. The discharge tray 41 may be drawable. The discharge tray 41 may be capable of making reciprocating movement in the depth direction Y. The discharge tray 41 in the present embodiment is movable to a position shown in FIG. 1 where the discharge tray 41 is stored in the enclosure 21 and a position shown in FIG. 2 where the discharge tray 41 protrudes forward beyond the front surface 21f.

### Loading Portion

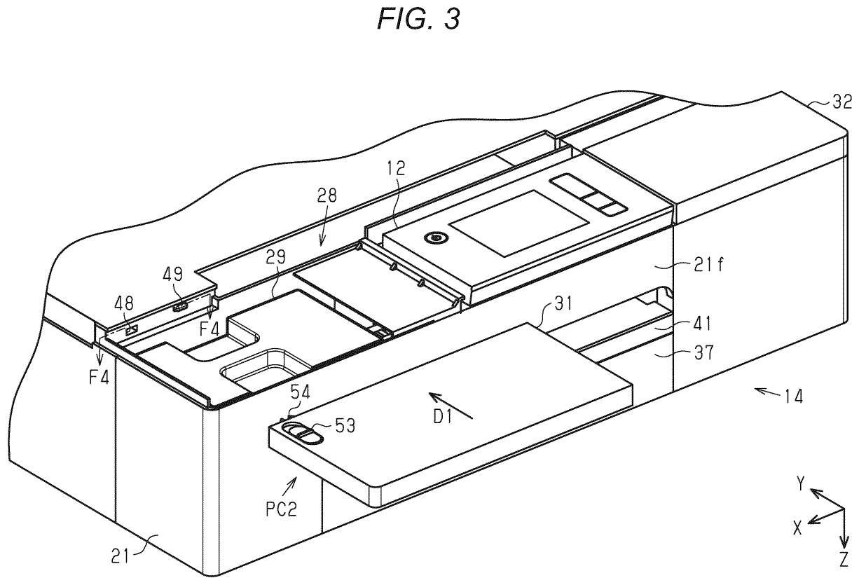

The loading portion 28 may be adjacent to the operation panel 12 in the width direction X, as shown in FIG. 3. The loading portion 28 has a loading space into which the waste liquid storing body 29 is loadable. The loading portion 28 may include an engagement receiver 48 and a pusher 49. The engagement receiver 48 in the present embodiment opens at a rear wall surface of the loading portion 28.

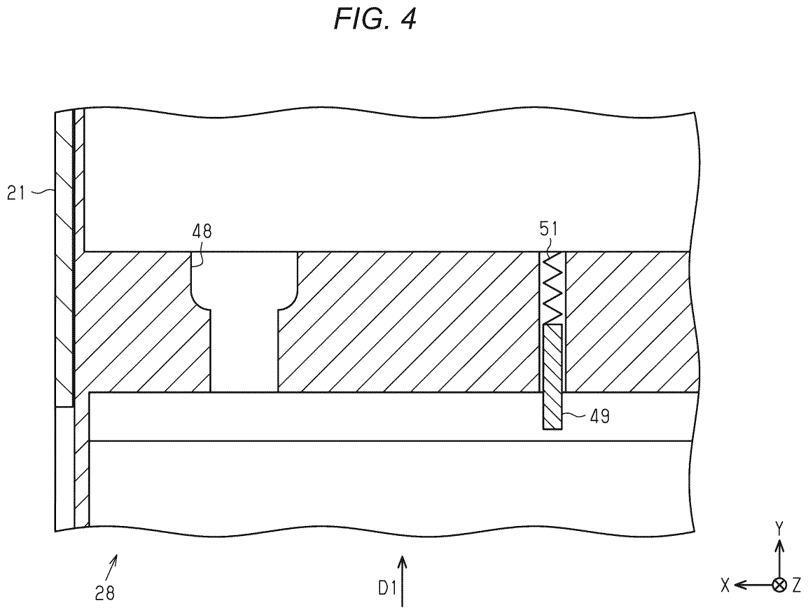

The loading portion 28 may include a first spring 51, as shown in FIG. 4. The first spring 51 urges the pusher 49 in the direction opposite a first direction D1. The term “urging” refers to pushing back or pulling back a target object against a force applied to the target object. The first direction D1 in the present embodiment is a direction parallel to the Y-axis. The first direction D1 in the present embodiment is the same as the depth direction Y and is a rearward direction. The first spring 51 pushes the pusher 49 in a forward direction, which is the direction opposite the first direction D1.

### First Maintenance Cover

The first maintenance cover 31 can be located at a non-cover position PC2, as shown in FIG. 3. The non-cover position PC2 is an example of a first non-cover position. The non-cover position PC2 is a position away from the enclosure 21. The non-cover position PC2 is a position where the loading portion 28 is not closed. The first maintenance cover 31 located at the non-cover position PC2 does not cover the loading space of the loading portion 28. The first maintenance cover 31 is displaced to the non-cover position PC2 to expose the loading portion 28. When the first maintenance cover 31 is at the non-cover position PC2, the waste liquid storing body 29 is attachable to and detachable from the loading portion 28.

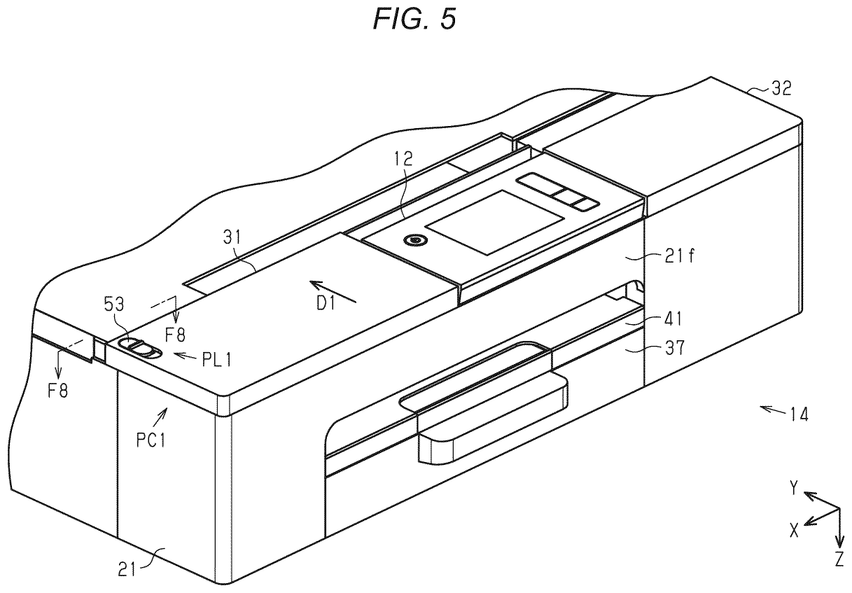

The first maintenance cover 31 is slidable in the first direction D1 and the direction opposite the first direction D1, as shown in FIGS. 3 and 5. The first maintenance cover 31 is caused to slide in the first direction D1 so that the first maintenance cover 31 is displaced from the non-cover position PC2 shown in FIG. 3 to a cover position PC1 shown in FIG. 5. The first maintenance cover 31 located at the cover position PC1 covers the loading space of the loading portion 28. The first maintenance cover 31 located at the cover position PC1 closes the loading portion 28 from above. The cover position PC1 is a position at which the loading portion 28 is closed. The first maintenance cover 31 is displaced from the cover position PC1 to the non-cover position PC2 when caused to slide in the direction opposite the first direction D1.

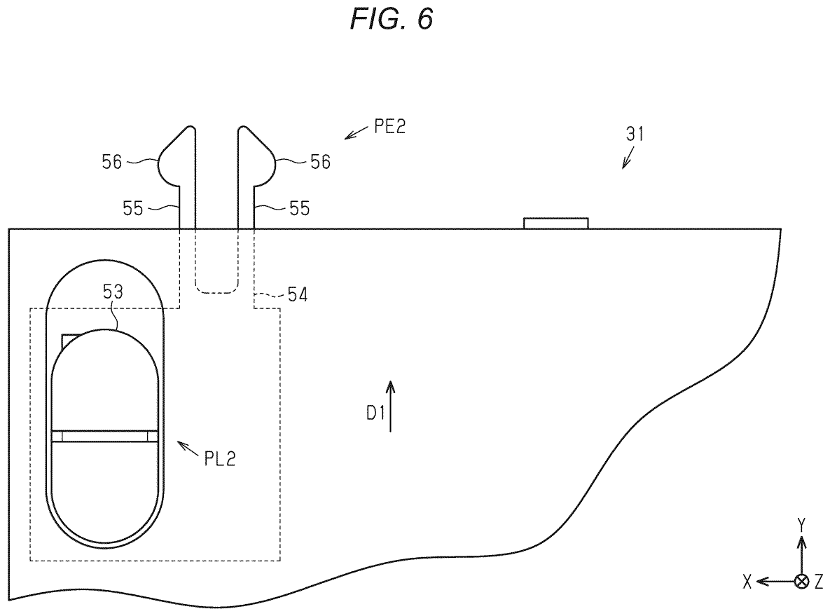

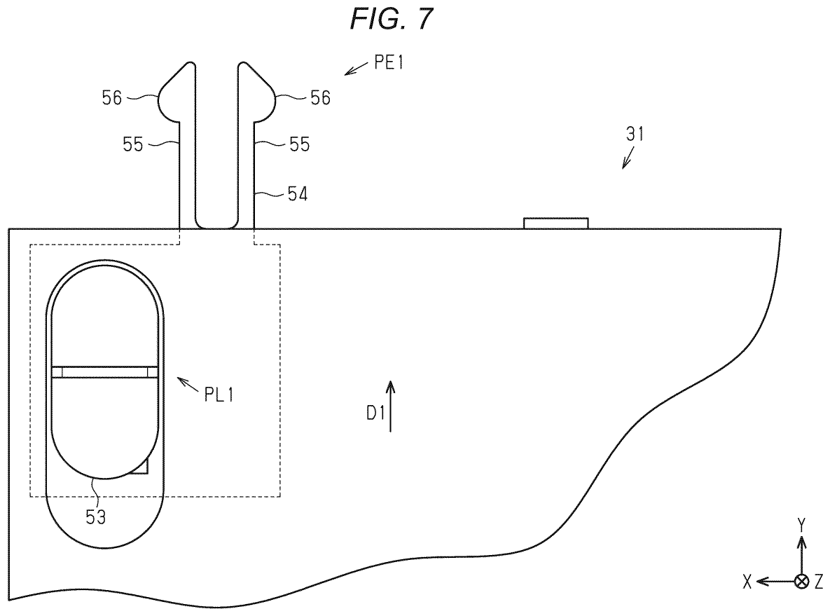

The first maintenance cover 31 includes an operation portion 53 and an engager 54, as shown in FIGS. 6 and 7.

The operation portion 53 is movable in the first direction D1 and the direction opposite the first direction D1 when externally operated. The operation portion 53 is slidable. The operation portion 53 is movable to a locked position PL1 shown in FIG. 7 and an unlocked position PL2 shown in FIG. 6.

The engager 54 may include arms 55 and claws 56. The arms 55 may extend in the first direction D1. The arms 55 may be deformable in a way that they bend. The claws 56 are provided at the tips of the arms 55 and overhang from the arms 55. The engager 54 in the present embodiment includes a pair of arms 55 and a pair of claws 56. The pair of claws 56 face outward away from each other.

The engager 54 is attached to the operation portion 53. The engager 54 moves in conjunction with the movement of the operation portion 53. The engager 54 is movable in the first direction D1 and the direction opposite the first direction D1. The engager 54 is slidable. The engager 54 moves in the first direction D1 and the direction opposite the first direction D1 to move to an engagement position PE1 shown in FIG. 7 and a non-engagement position PE2 shown in FIG. 6, respectively. The engagement position PE1 is a position where the engager 54 can engage with the engagement receiver 48. The non-engagement position PE2 is a position where the engager 54 cannot engage with the engagement receiver 48.

When the operation portion 53 is located at the unlocked position PL2, the engager 54 is located at the non-engagement position PE2, as shown in FIG. 6. The operation portion 53 located at the unlocked position PL2 moves to the locked position PL1 shown in FIG. 7 when moved in the first direction D1. When the operation portion 53 is moved in the first direction D1, the engager 54 moves to the engagement position PE1. When the operation portion 53 is located at the locked position PL1, the engager 54 is located at the engagement position PE1. When the operation portion 53 is moved in the direction opposite the first direction D1, the engager 54 moves to the non-engagement position PE2.

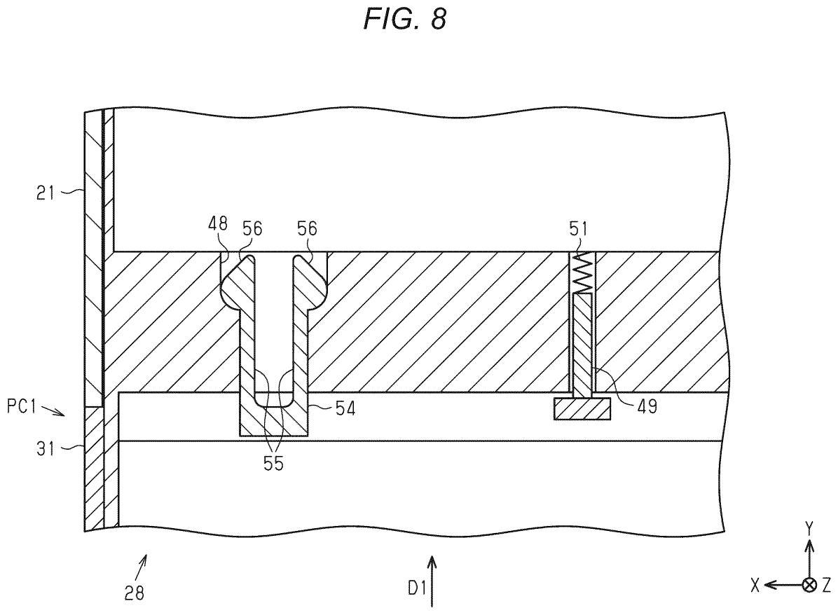

When the first maintenance cover 31 is located at the cover position PC1 and the operation portion 53 is located at the locked position PL1, the engager 54 engages with the engagement receiver 48, as shown in FIGS. 5 and 8.

The engager 54 makes the engagement in a way that the pair of claws 56 are caught by the engagement receiver 48, as shown in FIG. 8. The forward movement of the first maintenance cover 31 is restricted by the engagement of the engager 54 with the engagement receiver 48.

The first maintenance cover 31 may overlap with the reading unit 13 in the depth direction Y, as shown in FIG. 1. The rear end of the first maintenance cover 31 located at the cover position PC1 may be located behind the front end of the reading unit 13 located at the reading position PR1. At least a portion of the first maintenance cover 31 may enter the space below the reading unit 13. In other words, the reading unit 13 may be above the first maintenance cover 31. At least a portion of the first maintenance cover 31 located at the cover position PC1 may overlap with at least a portion of the reading unit 13 located at the reading position PR1. When the first maintenance cover 31 is located at the cover position PC1 and the reading unit 13 is located at the reading position PR1, at least a portion of the operation portion 53 may overlap with the reading unit 13. The reading unit 13 located at the reading position PR1 may hide at least a portion of the operation portion 53. When the reading unit 13 is at the reading position PR1, the operation of the operation portion 53 may be prohibited. When the reading unit 13 is located at the non-reading position PR2, the user is allowed to operate the operation portion 53. When the reading unit 13 is located at the non-reading position PR2, the first maintenance cover 31 can be attached to and detached from the recording apparatus 11.

### Effects of First Embodiment

Effects of the present embodiment will be described.

The pusher 49 can press the first maintenance cover 31 located at the cover position PC1, as shown in FIG. 8. The pusher 49 pushes the first maintenance cover 31 forward. The force with which the pusher 49 pushes the first maintenance cover 31 is smaller than the force with which the engager 54 and the engagement receiver 48 restrict the movement of the first maintenance cover 31. Therefore, when the operation portion 53 is at the locked position PL1, the first maintenance cover 31 is held at the cover position PC1.

When the operation portion 53 is moved in the direction opposite the first direction D1, the engager 54 disengages from the engagement receiver 48. The first maintenance cover 31 is shifted from the cover position PC1 in the direction opposite the first direction D1 by the force with which the user moves the operation portion 53 in the direction opposite the first direction D1 and the force exerted by the pusher 49. The user can detach the first maintenance cover 31 by further displacing the first maintenance cover 31 in the direction opposite the first direction D1.

### Advantages of First Embodiment

Advantages of the present embodiment will be described.
(1-1) When the operation portion 53 is moved in the direction opposite the first direction D1, the engager 54 moves to the non-engagement position PE2. That is, when the operation portion 53 is moved in the direction opposite the first direction D1, the engager 54 disengages from the engagement receiver 48, so that the first maintenance cover 31 becomes movable. The first maintenance cover 31 is displaced to the non-cover position PC2 when caused to slide in the direction opposite the first direction D1. The configuration in which the direction in which the user operates the operation portion 53 is the same as the direction in which the first maintenance cover 31 is caused to slide improves the user's operability of the operation portion 53 and the first maintenance cover 31.
(1-2) The engager 54 moves in the same direction as the operation portion 53. The force with which the user operates the operation portion 53 can therefore be used as it is to move the engager 54. Loss of the operation force can therefore be reduced.
(1-3) The reading unit 13 located at the reading position PR1 is located above the first maintenance cover 31 and therefore overlaps with the first maintenance cover 31. A concern that the first maintenance cover 31 is inadvertently detached can therefore be reduced.
(1-4) The reading unit 13 located at the reading position PR1 overlaps with the operation portion 53 of the first maintenance cover 31 located at the cover position PC1. A concern that the user inadvertently moves the operation portion 53 can therefore be reduced.
(1-5) The reading unit 13 includes the reader 17. The size of the apparatus can therefore be reduced as compared with a case where the reader 17 is separately provided.
(1-6) The first maintenance cover 31 covers the waste liquid storing body 29. The operability of the first maintenance cover 31 is improved as described in (1-1). A concern that it takes time for the user to detach the first maintenance cover 31 so that the user inadvertently touches the waste liquid storing body 29 can therefore be reduced.

### Second Embodiment

A second embodiment of the recording apparatus will next be described with reference to the drawings. Note that the second embodiment differs from the first embodiment in terms of the configurations of the loading portion and the first maintenance cover. The other points in the second embodiment are substantially the same as those in the first embodiment, so that the same elements have the same reference characters, and no duplicated description thereof will be made.

### Loading Portion

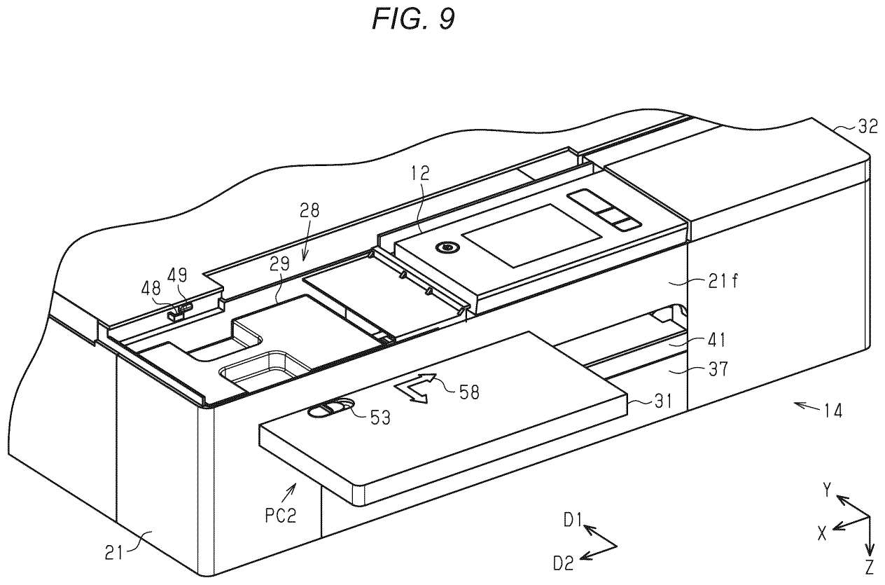

The loading portion 28 may include the engagement receiver 48 and the pusher 49, as shown in FIG. 9. The engagement receiver 48 in the present embodiment protrudes forward from the rear wall surface of the loading portion 28. The pusher 49 is urged in the direction opposite the first direction D1 and can push the first maintenance cover 31 located at the cover position PC1.

### First Maintenance Cover

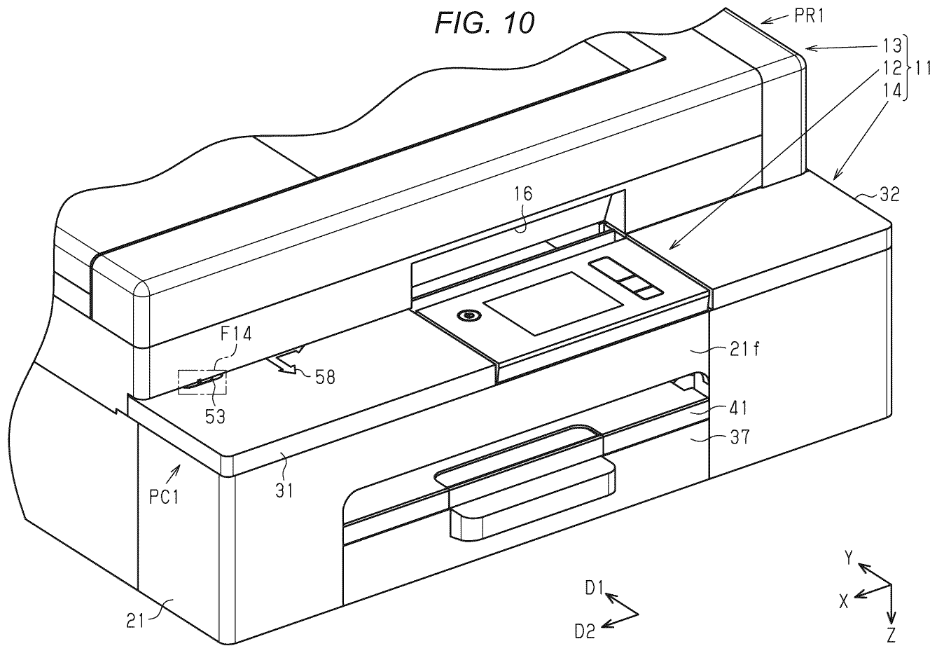

The first maintenance cover 31 is slidable in the first direction D1 and the direction opposite the first direction D1, as shown in FIGS. 9 and 10. The first maintenance cover 31 is displaced from the non-cover position PC2 shown in FIG. 9 to the cover position PC1 shown in FIG. 10 when caused to slide in the first direction D1. The first maintenance cover 31 is displaced from the cover position PC1 to the non-cover position PC2 when caused to slide in the direction opposite the first direction D1.

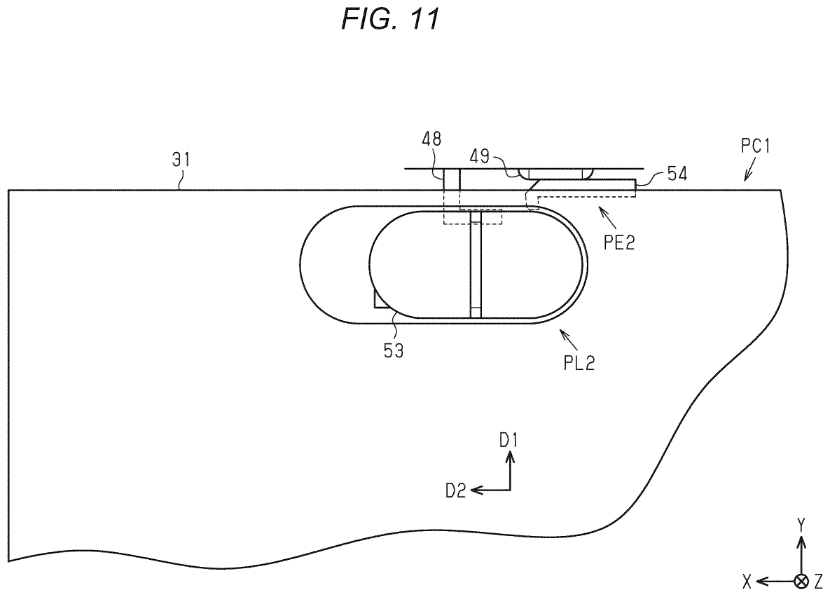

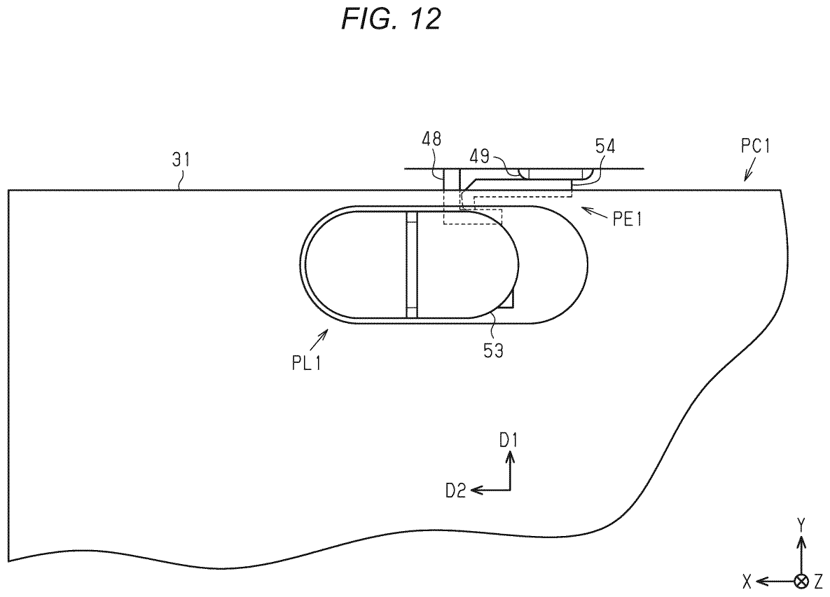

The first maintenance cover 31 may have a mark 58. The mark 58 may indicate operation directions in accordance with which the user detaches the first maintenance cover 31. The mark 58 may be an arrow indicating the direction toward the non-cover position PC2 in the state in which the first maintenance cover 31 is located at the cover position PC1. The mark 58 may be an arrow indicating the direction toward the unlocked position PL2 shown in FIG. 11 in the state in which the operation portion 53 is located at the locked position PL1 shown in FIG. 12.

The operation portion 53 is movable in a second direction D2 and the direction opposite the second direction D2 when externally operated, as shown in FIGS. 11 and 12. The operation portion 53 is slidable. The second direction D2 is a direction different from the first direction D1. The second direction D2 in the present embodiment is a direction parallel to the X-axis. The second direction D2 is the same as the width direction X. The operation portion 53 is movable to the locked position PL1 shown in FIG. 12 and the unlocked position PL2 shown in FIG. 11. The operation portion 53 moves to the locked position PL1 when moved in the second direction D2. The operation portion 53 moves to the unlocked position PL2 when moved in the direction opposite the second direction D2.

The engager 54 is attached to the operation portion 53. The engager 54 moves in conjunction with the movement of the operation portion 53. The engager 54 is movable in the second direction D2 and the direction opposite the second direction D2. The engager 54 is slidable. The engager 54 moves to the engagement position PE1 shown in FIG. 12 and the non-engagement position PE2 shown in FIG. 11 when moved in the second direction D2 and the direction opposite the second direction D2, respectively.

When the operation portion 53 is located at the unlocked position PL2, the engager 54 is located at the non-engagement position PE2, as shown in FIG. 11. The operation portion 53 located at the unlocked position PL2 moves to the locked position PL1 shown in FIG. 12 when moved in the second direction D2. When the operation portion 53 is moved in the second direction D2, the engager 54 moves to the engagement position PE1. When the operation portion 53 is located at the locked position PL1, the engager 54 is located at the engagement position PE1. When the operation portion 53 is moved in the direction opposite the second direction D2, the engager 54 moves to the non-engagement position PE2.

When the first maintenance cover 31 is located at the cover position PC1 and the operation portion 53 is located at the locked position PL1, the engager 54 engages with the engagement receiver 48, as shown in FIG. 12. At this point in time, the engager 54 is located behind the engagement receiver 48. The forward movement of the first maintenance cover 31 is therefore restricted.

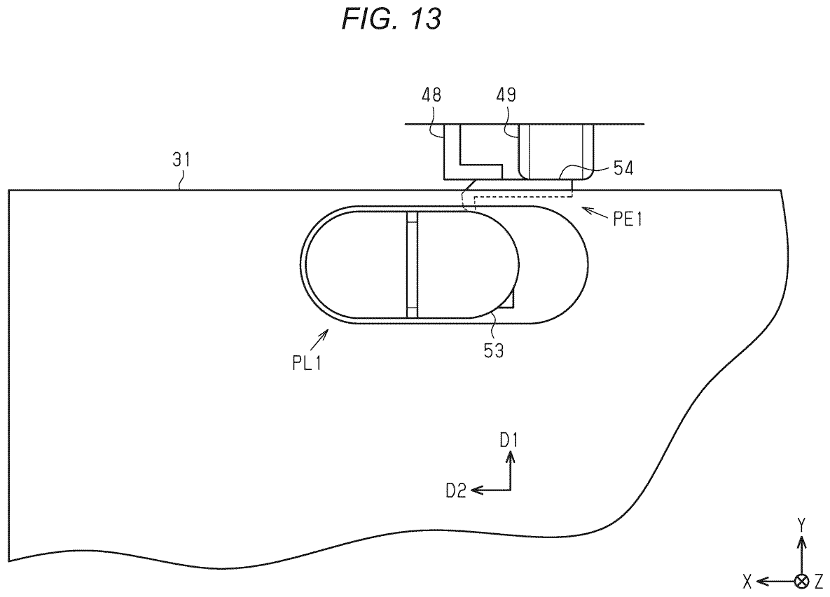

The first maintenance cover 31 moving from the non-cover position PC2 in the first direction D1 in the state in which the engager 54 is located at the engagement position PE1 interferes with the loading portion 28 before moving to the cover position PC1, as shown in FIG. 13. Specifically, in the first maintenance cover 31, the engager 54 located at the engagement position PE1 hits the engagement receiver 48. The movement of the first maintenance cover 31 in the first direction D1 is therefore restricted before the first maintenance cover 31 reaches the cover position PC1.

The reading unit 13 may be above the first maintenance cover 31, as shown in FIG. 10. At least a portion of the first maintenance cover 31 located at the cover position PC1 may overlap with at least a portion of the reading unit 13 located at the reading position PR1. When the first maintenance cover 31 is located at the cover position PC1 and the reading unit 13 is located at the reading position PR1, at least a portion of the operation portion 53 may overlap with the reading unit 13.

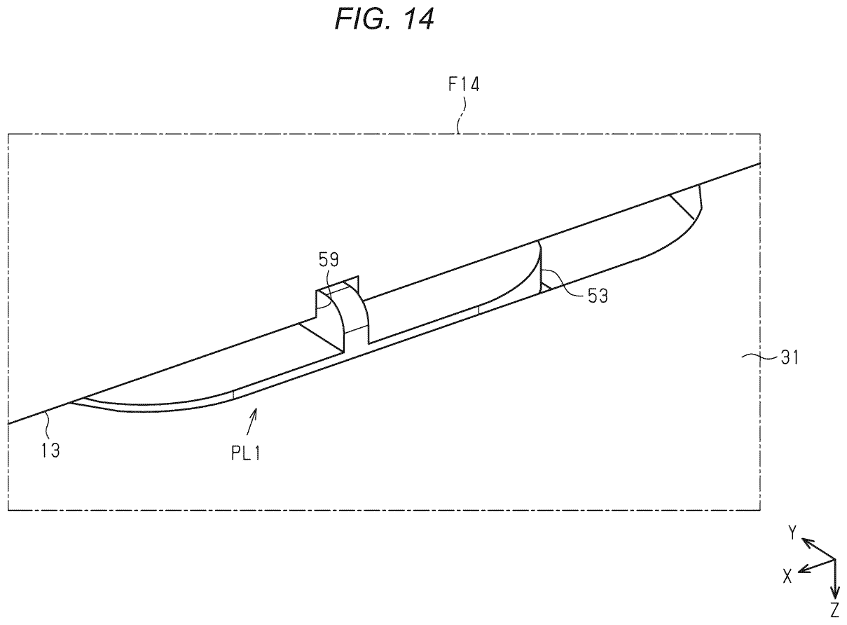

The reading unit 13 may have a clearance groove 59, as shown in FIG. 14. When the first maintenance cover 31 is located at the cover position PC1 and the reading unit 13 is located at the reading position PR1, a portion of the operation portion 53 located at the locked position PL1 is located in the clearance groove 59. However, when the operation portion 53 is not located at the locked position PL1 but is located, for example, at the unlocked position PL2, the operation portion 53 is out of the clearance groove 59 and interferes with the reading unit 13. Therefore, in the state in which the first maintenance cover 31 is located at the cover position PC1 and the operation portion 53 is located at the unlocked position PL2, the reading unit 13 moving from the non-reading position PR2 to the reading position PR1 interferes with the operation portion 53 before moving to the reading position PR1. When the detector 23 detects that the reading unit 13 is not located at the reading position PR1, the controller 22 may cause, for example, the operation panel 12 to notify that the first maintenance cover 31 is not fixed.

### Effects of Second Embodiment

Effects of the present embodiment will be described.

The pusher 49 pushes the first maintenance cover 31 located at the cover position PC1 in the direction opposite the first direction D1 when urged by the first spring 51, as shown in FIG. 12. The pusher 49 may push the engager 54 forward.

When the operation portion 53 located at the locked position PL1 is moved in the direction opposite the second direction D2, the engager 54 disengages from the engagement receiver 48. The first maintenance cover 31 is shifted from the cover position PC1 in the direction opposite the first direction D1 by the force exerted by the pusher 49. The user can detach the first maintenance cover 31 by further displacing the first maintenance cover 31 in the direction opposite the first direction D1.

### Advantages of Second Embodiment

Advantages of the present embodiment will be described.
(2-1) The pusher 49 pushes the first maintenance cover 31 located at the cover position PC1 toward the non-cover position PC2. Therefore, when the engager 54 disengages from the engagement receiver 48, the first maintenance cover 31 moves in the direction opposite the first direction D1. The direction in which the first maintenance cover 31 is detached is therefore readily known, so that the user's operability of the first maintenance cover 31 can be improved.
(2-2) The configuration in which the pusher 49 pushes the first maintenance cover 31 allows the user to readily know the direction in which the first maintenance cover 31 is detached. Therefore, even when the direction in which the operation portion 53 is moved differs from the direction in which the first maintenance cover 31 is caused to slide, a concern that the user is confused at how to detach the first maintenance cover 31 can be reduced. The operation portion 53 can therefore be configured with increased flexibility.
(2-3) In the state in which the engager 54 is located at the engagement position PE1, the engager 54 interferes with the loading portion 28. The first maintenance cover 31 cannot therefore be displaced to the cover position PC1. A concern that the cover is erroneously attached can therefore be reduced.
(2-4) The detector 23 detects whether the reading unit 13 is open or closed. A concern that the reading unit 13 not located at the reading position PR1 is used can therefore be reduced.

### Third Embodiment

A third embodiment of the recording apparatus will next be described with reference to the drawings. Note that the third embodiment differs from the first embodiment in terms of the configurations of the loading portion and the first maintenance cover. The other points in the third embodiment are substantially the same as those in the first embodiment, so that the same elements have the same reference characters, and no duplicated description thereof will be made.

### Loading Portion

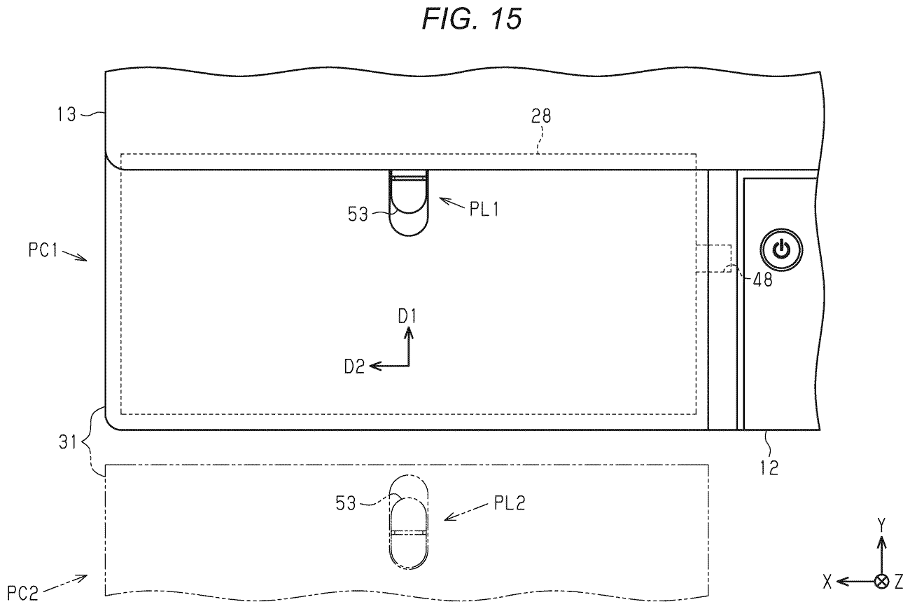

The loading portion 28 includes the engagement receiver 48, as shown in FIG. 15. The engagement receiver 48 in the present embodiment opens at a side wall surface of the loading portion 28. The engagement receiver 48 may be located between the first maintenance cover 31 located at the cover position PC1 and the operation panel 12 in the width direction X.

### First Maintenance Cover

The first maintenance cover 31 is slidable in the first direction D1 and the direction opposite the first direction D1, as shown in FIG. 15. The first maintenance cover 31 is displaced from the non-cover position PC2 indicated by the two-dot chain line in FIG. 15 to the cover position PC1 when caused to slide in the first direction D1. The first maintenance cover 31 is displaced from the cover position PC1 to the non-cover position PC2 when caused to slide in the direction opposite the first direction D1.

The first maintenance cover 31 includes the operation portion 53. The operation portion 53 is movable in the first direction D1 and the direction opposite the first direction D1 when externally operated. The operation portion 53 is slidable. The operation portion 53 is movable to the locked position PL1 and the unlocked position PL2.

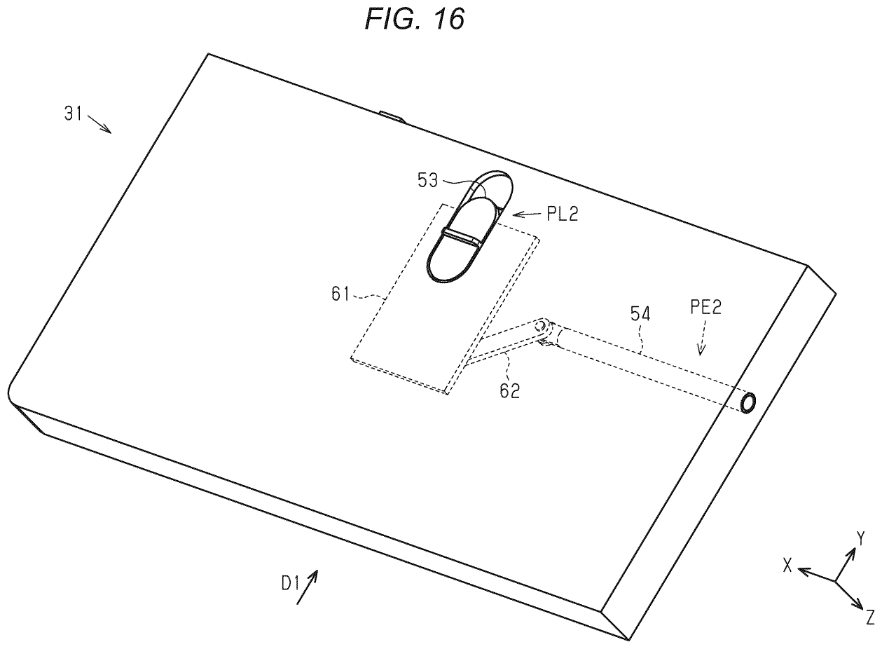

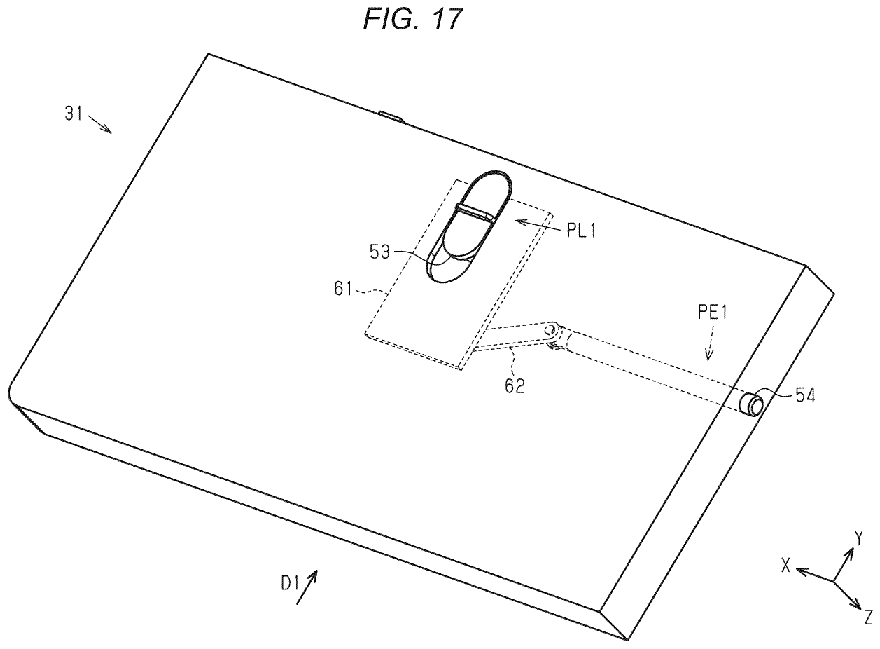

The first maintenance cover 31 may include the engager 54, a first link 61, and a second link 62, as shown in FIGS. 16 and 17.

The first link 61 is coupled to the operation portion 53 and the second link 62. The second link 62 couples the first link 61 and the engager 54 to each other. The engager 54 moves in conjunction with the movement of the operation portion 53. The engager 54 is movable in the second direction D2 and the direction opposite the second direction D2. The engager 54 is slidable. The engager 54 moves to the engagement position PE1 shown in FIG. 17 and the non-engagement position PE2 shown in FIG. 16 when moved in the second direction D2 and the direction opposite the second direction D2, respectively.

When the operation portion 53 is located at the unlocked position PL2, the engager 54 is located at the non-engagement position PE2. The operation portion 53 located at the unlocked position PL2 moves to the locked position PL1 when moved in the first direction D1. When the operation portion 53 is moved in the first direction D1, the engager 54 moves to the engagement position PE1. When the operation portion 53 is located at the locked position PL1, the engager 54 is located at the engagement position PE1. When the operation portion 53 is moved in the direction opposite the first direction D1, the engager 54 moves to the non-engagement position PE2.

When the first maintenance cover 31 is located at the cover position PC1 and the operation portion 53 is located at the locked position PL1, the engager 54 engages with the engagement receiver 48, as shown in FIG. 15. The forward movement of the first maintenance cover 31 is restricted by the engagement of the engager 54 with the engagement receiver 48.

The engager 54 located at the engagement position PE1 protrudes beyond the first maintenance cover 31, as shown in FIG. 17. The first maintenance cover 31 moving in the first direction D1 from the non-cover position PC2 in the state in which the engager 54 is located at the engagement position PE1 interferes with the loading portion 28 before moving to the cover position PC1. The first maintenance cover 31 may interfere with a member through which the loading portion 28 opens. The movement of the first maintenance cover 31 in the first direction D1 is restricted before the first maintenance cover 31 reaches the cover position PC1.

### Effects of Third Embodiment

Effects of the present embodiment will be described.

When the operation portion 53 is moved in the direction opposite the first direction D1, the engager 54 disengages from the engagement receiver 48, as shown in FIG. 15. The user can detach the first maintenance cover 31 by displacing the first maintenance cover 31 in the direction opposite the first direction D1.

### Advantages of Third Embodiment

Advantages of the present embodiment will be described.
(3-1) The engager 54 moves in a direction different from the direction in which the first maintenance cover 31 is caused to slide. Therefore, even when a force acts on the first maintenance cover 31 in the state in which the engager 54 engages with the engagement receiver 48, the first maintenance cover 31 is unlikely to move.

### Fourth Embodiment

A fourth embodiment of the recording apparatus will next be described with reference to the drawings. Note that the fourth embodiment differs from the first embodiment in terms of the configuration of the first maintenance cover. The other points in the fourth embodiment are substantially the same as those in the first embodiment, so that the same elements have the same reference characters, and no duplicated description thereof will be made.

### First Maintenance Cover

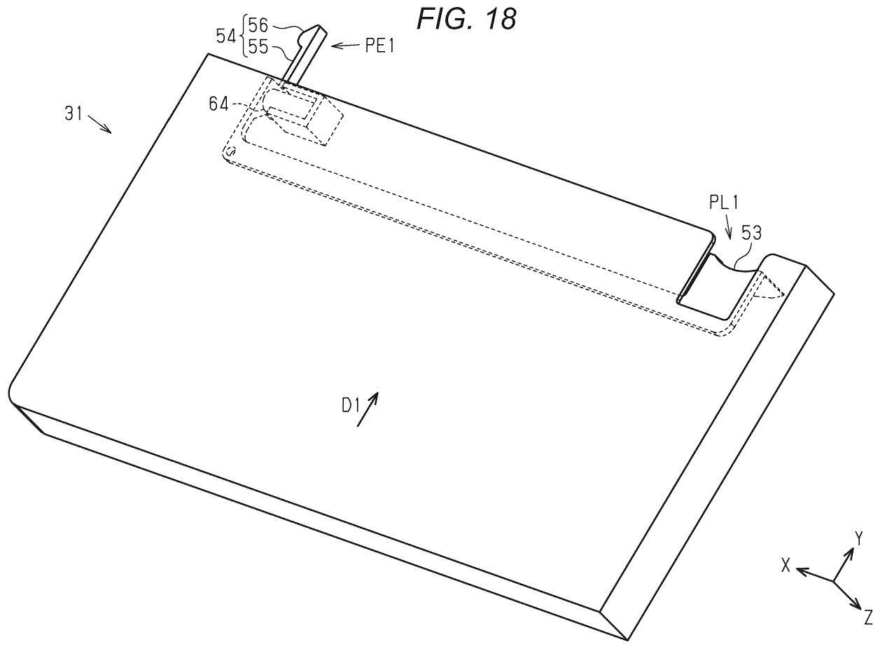

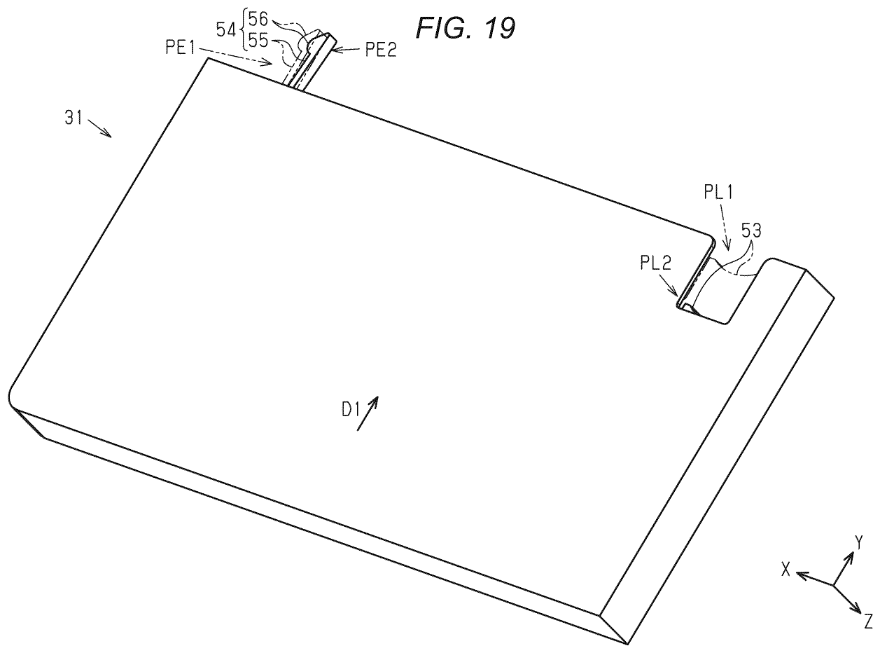

The first maintenance cover 31 may include the operation portion 53, the engager 54, and a second spring 64, as shown in FIGS. 18 and 19. In the width direction X, the operation portion 53 may be located at one end of the first maintenance cover 31, and the engager 54 may be located at the other end thereof. The operation portion 53 is movable in the first direction D1 and the direction opposite the first direction D1 when externally operated. The operation portion 53 is movable to the locked position PL1 and the unlocked position PL2.

The engager 54 is integrated with the operation portion 53. The engager 54 moves in conjunction with the movement of the operation portion 53. The operation portion 53 and the engager 54 can make pivotal motion around an axis. The pivotal motion refers to rotation made around an axis by an angle of rotation smaller than 360 degrees. The engager 54 moves to the engagement position PE1 and the non-engagement position PE2 when caused to make pivotal motion. The second spring 64 pushes the engager 54 located at the non-engagement position PE2 toward the engagement position PE1.

When the operation portion 53 is located at the unlocked position PL2, the engager 54 is located at the non-engagement position PE2, as shown in FIG. 19. The operation portion 53 located at the unlocked position PL2 moves to the locked position PL1 when moved in the first direction D1 by the urging force exerted by the second spring 64. When the operation portion 53 is moved in the first direction D1, the engager 54 moves to the engagement position PE1. When the operation portion 53 is located at the locked position PL1, the engager 54 is located at the engagement position PE1. When the operation portion 53 is moved in the direction opposite the first direction D1, the engager 54 moves to the non-engagement position PE2.

### Effects of Fourth Embodiment

Effects of the present embodiment will be described.

When the operation portion 53 is moved in the direction opposite the first direction D1, the engager 54 disengages from the engagement receiver 48, as shown in FIG. 19. The user can detach the first maintenance cover 31 by displacing the first maintenance cover 31 in the direction opposite the first direction D1.

### Advantages of Fourth Embodiment

Advantages of the present embodiment will be described.
(4-1) The engager 54 makes pivotal motion. The engager 54 can therefore be moved with a small force as compared, for example, with the case where the engager 54 is caused to slide.

### Fifth Embodiment

A fifth embodiment of the recording apparatus will next be described with reference to the drawings. Note that the fifth embodiment differs from the first embodiment in terms of the configurations of the recording apparatus and the waste liquid storing body. The other points of the fifth embodiment are substantially the same as those of the embodiments described above, so that the same elements have the same reference characters, and no duplicated description thereof will be made.

### Recording Apparatus

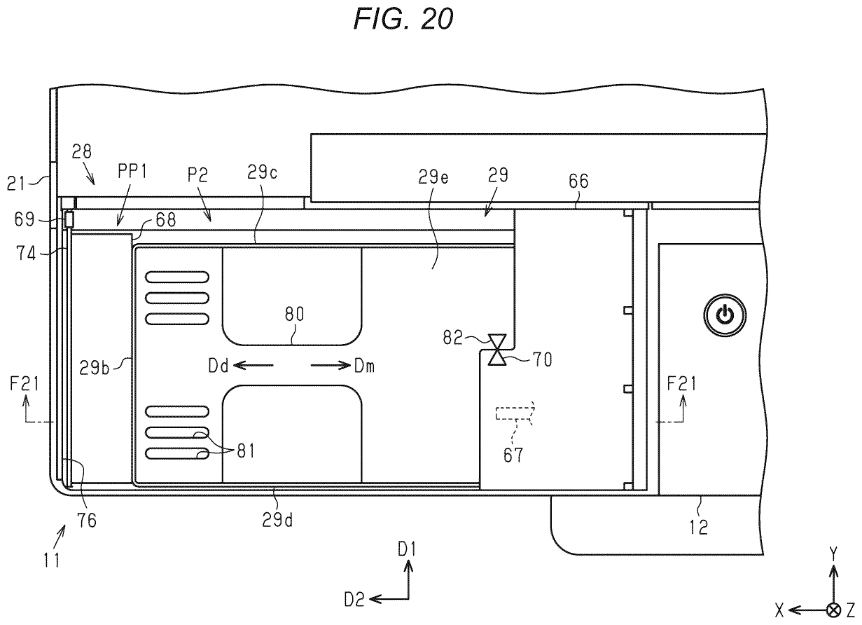

The recording apparatus 11 may include a cover portion 66, a discharger 67, a protector 68, and an urging member 69, as shown in FIG. 20. The cover portion 66 covers the discharger 67 from above. The cover portion 66 may be provided with a first mark 70. The cover portion 66, the discharger 67, the protector 68, and the urging member 69 may be located in the loading space of the loading portion 28. That is, the cover portion 66, the discharger 67, the protector 68, and the urging member 69 are provided in the loading portion 28. The cover portion 66, the discharger 67, the protector 68, and the urging member 69 are covered by the first maintenance cover 31 shown in FIG. 1 and located at the cover position PC1.

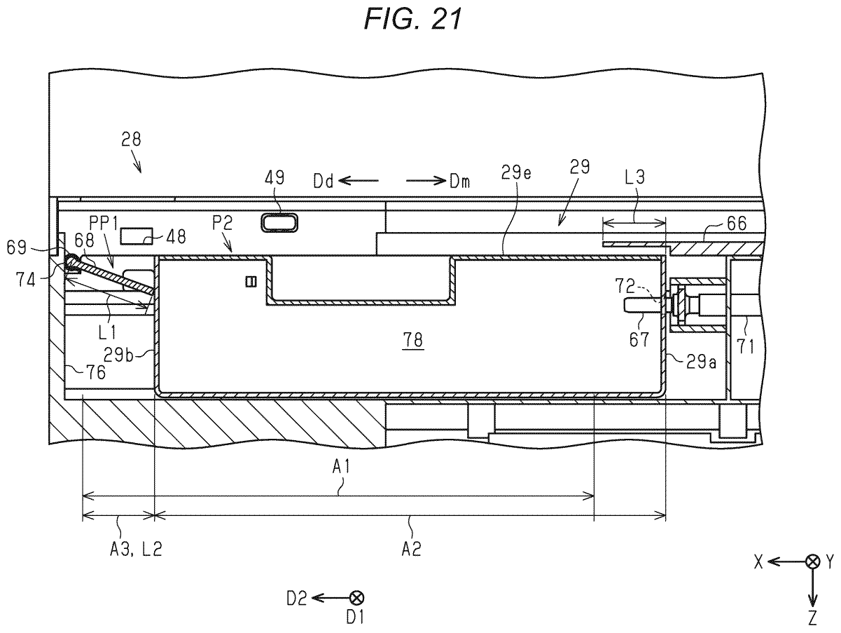

The recording apparatus 11 may include a discharge channel 71, as shown in FIG. 21. The discharge channel 71 couples the maintenance portion 27 to the discharger 67. The discharge channel 71 sends the waste liquid collected by the maintenance portion 27 to the discharger 67. The discharger 67 constitutes the downstream end of the discharge channel 71. The discharger 67 is, for example, a hollow needle.

The waste liquid storing body 29 has an insertion port 72. The discharger 67 is coupled to the waste liquid storing body 29 when inserted into the insertion port 72. The discharger 67 discharges the waste liquid into the waste liquid storing body 29. The discharger 67 extends in a detachment direction Dd. The detachment direction Dd in the present embodiment is a direction parallel to the X-axis. The detachment direction Dd in the present embodiment is the same as the width direction X and the second direction D2.

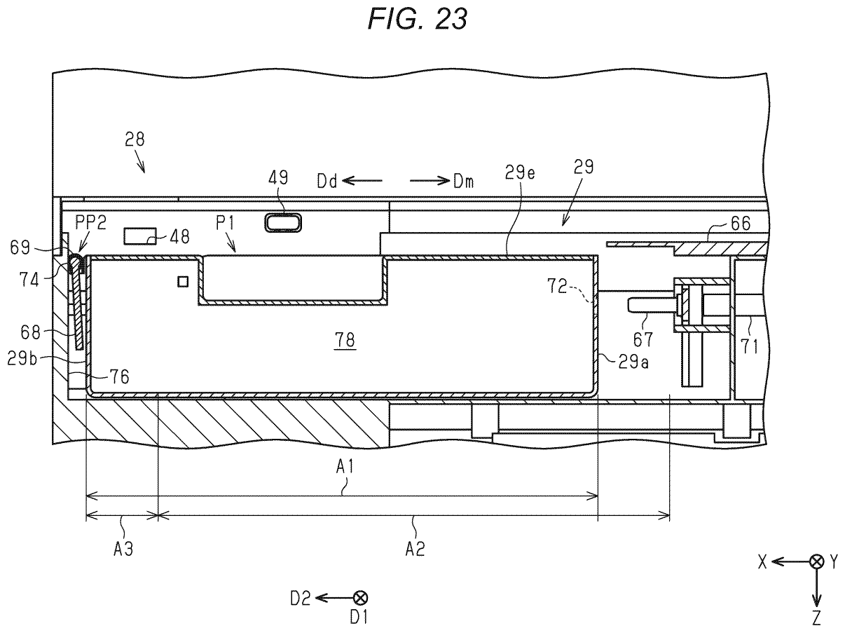

The protector 68 is provided to be pivotable around a pivotal shaft 74, as shown in FIG. 21. The pivotal shaft 74 may be integrated with the protector 68 and may therefore be a portion of the protector 68. The pivotal shaft 74 may be provided separately from the protector 68. The pivotal shaft 74 may extend in the first direction D1 along a wall portion 76 of the loading portion 28. The protector 68 is displaceable to a protection position PP1 shown in FIG. 21 and a retracted position PP2 shown in FIG. 23. The protection position PP1 may be a position where the tip of the protector 68 hits the waste liquid storing body 29. The protection position PP1 may instead be a position where the protector 68 hits a stopper that is not shown. The urging member 69 urges the protector 68 toward the protection position PP1. The urging member 69 pushes the protector 68 located at the retracted position PP2 toward the protection position PP1. The urging member 69 is, for example, a helical torsion spring.

### Waste Liquid Storing Body

The waste liquid storing body 29 includes a storage chamber 78, as shown in FIG. 21. The storage chamber 78 can store the waste liquid flowing via the insertion port 72.

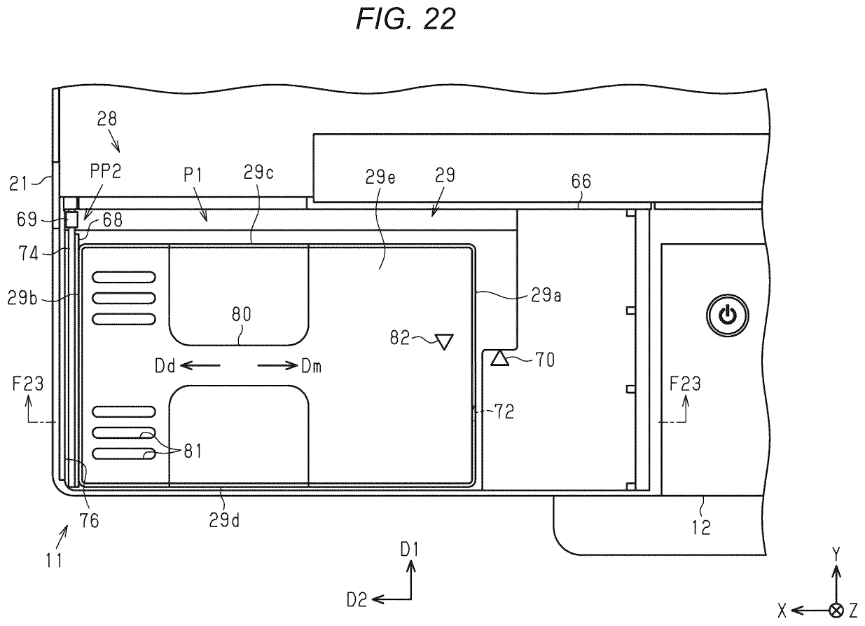

The waste liquid storing body 29 may have a first side surface 29a, a second side surface 29b, a third side surface 29c, a fourth side surface 29d, and a top surface 29e, as shown in FIG. 22. The waste liquid storing body 29 in the present embodiment has a substantially rectangular parallelepiped shape. The waste liquid storing body 29 is loaded into the loading portion 28 in a loaded posture.

The first side surface 29a is a forefront surface in a loading direction Dm. The insertion port 72 is located at the first side surface 29a. The loading direction Dm is the direction opposite the detachment direction Dd.

The second side surface 29b is a surface opposite the first side surface 29a in the loading direction Dm. The second side surface 29b is a forefront surface in the detachment direction Dd.

The third side surface 29c, the fourth side surface 29d, and the top surface 29e are located between the first side surface 29a and the second side surface 29b in the loading direction Dm. The third side surface 29c, the fourth side surface 29d, and the top surface 29e each intersect with the first side surface 29a and the second side surface 29b. The third side surface 29c is located rearward in the depth direction Y in the loaded posture. The fourth side surface 29d is located forward in the depth direction Y in the loaded posture. The top surface 29e is located upward in the vertical direction Z in the loaded posture.

The waste liquid storing body 29 may have a gripper 80, one or more openings 81, and a second mark 82. The gripper 80, the opening 81, and the second mark 82 may be provided at the top surface 29e. The user can readily attach and detach the waste liquid storing body 29 to and from the loading portion 28 by holding the gripper 80. The gripper 80 may be provided at the second side surface 29b. The gripper 80 may be provided at the third side surface 29c. The gripper 80 may be provided at the fourth side surface 29d. The opening 81 exposes the storage chamber 78 to the outside. The opening 81 allows the waste liquid volatilized in the storage chamber 78 to exit out thereof. The opening 81 facilitates evaporation of the waste liquid.

The waste liquid storing body 29 is displaceable in the loading portion 28, as shown in FIGS. 20 to 23. The waste liquid storing body 29 in FIGS. 22 and 23 is located at a first position P1. The waste liquid storing body 29 in FIGS. 20 and 21 is located at a second position P2.

The first position P1 is a position where the discharger 67 is not inserted into the insertion port 72, as shown in FIG. 23. In the present embodiment, the region occupied by the waste liquid storing body 29 located at the first position P1 is referred to as a first region A1.

The user can detach the waste liquid storing body 29 from the loading portion 28 by moving the waste liquid storing body 29 located at the first position P1 upward in the vertical direction Z. The user moves the waste liquid storing body 29 located outside downward in the vertical direction Z to locate the waste liquid storing body 29 at the first position P1. The waste liquid storing body 29 located at the first position P1 is displaceable in the loading direction Dm. The waste liquid storing body 29 is loaded into the loading portion 28 when displaced in the loading direction Dm from the first position P1 to the second position P2.

The second position P2 is a position where the discharger 67 is inserted into the insertion port 72, as shown in FIG. 21. In the present embodiment, the region occupied by the waste liquid storing body 29 located at the second position P2 is referred to as a second region A2. The waste liquid storing body 29 located at the second position P2 is displaceable in the detachment direction Dd. The waste liquid storing body 29 is detached from the discharger 67 when displaced in the detachment direction Dd from the second position P2 to the first position P1. In the present embodiment, a region of the first region A1 that is the region that does not overlap with the second region A2 is referred to as a third region A3. The first region A1, the second region A2, and the third region A3 are each an empty space extending in the width direction X, the depth direction Y, and the vertical direction Z.

In the present embodiment, the length from the pivotal shaft 74 to the tip of the protector 68 is referred to as a first length L1. In the present embodiment, the length of the third region A3 in the loading direction Dm is referred to as a second length L2. In the present embodiment, when the waste liquid storing body 29 is located at the second position P2, the length over which the cover portion 66 and the waste liquid storing body 29 overlap with each other in the loading direction Dm is referred to as a third length L3. The first length L1 may be longer than the second length L2. The third length L3 may be shorter than the first length L1 and the second length L2. In the depth direction Y, the size of the protector 68 may be substantially equal to the size of the waste liquid storing body 29. In the depth direction Y, the size of the protector 68 may be substantially equal to the size of the third region A3.

When the waste liquid storing body 29 is at the second position P2, the protector 68 is located at the protection position PP1. The protection position PP1 is a position where the protector 68 covers at least a portion of the third region A3. In the waste liquid storing body 29 at the second position P2, the second side surface 29b faces the wall portion 76.

When the waste liquid storing body 29 is at the first position P1, the protector 68 is located at the retracted position PP2, as shown in FIG. 23. When the waste liquid storing body 29 is at the first position P1, the protector 68 is retracted from the protection position PP1. When the waste liquid storing body 29 is at the first position P1, the protector 68 is retracted with respect to the waste liquid storing body 29.

### Effects of Fifth Embodiment

Effects of the present embodiment will be described.

The waste liquid storing body 29 at the second position P2 receives the waste liquid discharged from the discharger 67, as shown in FIG. 21. When the waste liquid storing body 29 is at the second position P2, the protector 68 is located at the protection position PP1. The protector 68 located at the protection position PP1 covers the third region A3. That is, the protector 68 covers at least a portion of the space between the wall portion 76 and the second side surface 29b.

The front end of the protector 68 located at the protection position PP1 is located below the pivotal shaft 74. Therefore, when the waste liquid storing body 29 is displaced in the detachment direction Dd, the protector 68 is pushed by the waste liquid storing body 29 to pivot. The protector 68 allows displacement of the waste liquid storing body 29 in the detachment direction Dd.

When the waste liquid storing body 29 is moved to the first position P1, the protector 68 is located at the retracted position PP2, as shown in FIG. 23.

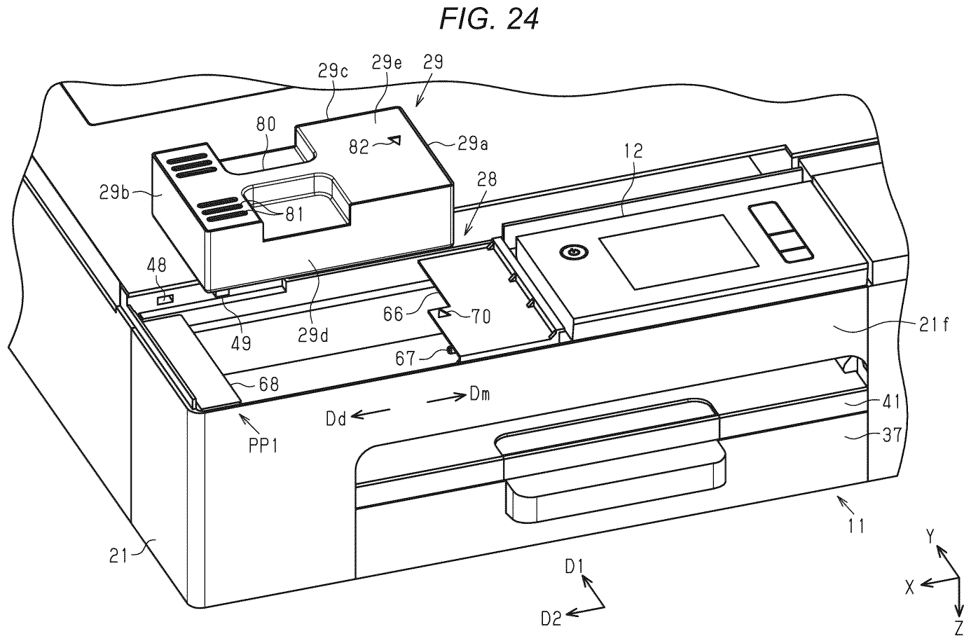

When the waste liquid storing body 29 is detached from the loading portion 28, the urging member 69 pushes up the protector 68 to the protection position PP1, as shown in FIG. 24. The protector 68 located at the protection position PP1 is located in the loading portion 28. To replace the waste liquid storing body 29, the user may position the waste liquid storing body 29 at the first position P1 by pushing down the protector 68 with a new waste liquid storing body 29. After the user positions the waste liquid storing body 29 at the first position P1, the user displaces the waste liquid storing body 29 in the loading direction Dm.

The protector 68 pivots in accordance with the displacement of the waste liquid storing body 29 in a way that the front end of the protector 68 comes into contact with the waste liquid storing body 29, as shown in FIG. 20. When the waste liquid storing body 29 is displaced to the second position P2, the first mark 70 and the second mark 82 are aligned with each other. Specifically, the first mark 70 and the second mark 82 are aligned with each other in the loading direction Dm.

### Advantages of Fifth Embodiment

Advantages of the present embodiment will be described.
(5-1) The waste liquid storing body 29 is loaded into the loading portion 28 when moved from the first position P1 to the second position P2. When the waste liquid storing body 29 is located at the second position P2, the third region A3 is empty. The protector 68 covers at least a portion of the third region A3 when the waste liquid storing body 29 is at the second position P2. A concern that foreign matter falls to the third region A3 is therefore reduced. Since the third region A3 is empty, the waste liquid storing body 29 located at the second position P2 is movable to the first position P1. When the waste liquid storing body 29 is at the first position P1, the protector 68 is retracted from the protection position PP1. A concern that the detachment of the waste liquid storing body 29 is hindered can therefore be reduced.
(5-2) The protector 68 is retracted with respect to the waste liquid storing body 29 located at the first position P1. Therefore, even when the protector 68 is provided at the loading portion 28, the waste liquid storing body 29 can be readily positioned at the first position P1.
(5-3) The waste liquid storing body 29 has the second side surface 29b opposite the insertion port 72. The loading portion 28 has the wall portion 76, which faces the second side surface 29b. When the waste liquid storing body 29 is at the second position P2, the third region A3 is located between the second side surface 29b and the wall portion 76. The protector 68 is pivotable around the pivotal shaft 74 provided along the wall portion 76. The size of the protector 68 can therefore be reduced as compared with a case where the pivotal shaft 74 is provided on the side facing the first side surface 29a.
(5-4) The first length L1 of the protector 68 is longer than the second length L2 of the third region A3. Therefore, creation of a gap between the protector 68 and the waste liquid storing body 29 can be avoided, so that fall of foreign matter to the third region A3 can be more effectively avoided.
(5-5) The cover portion 66 covers the discharger 67 from above. A concern that the user touches the discharger 67 can therefore be reduced. The third length L3, over which the waste liquid storing body 29 at the second position P2 overlaps with the cover portion 66, is shorter than the first length L1 of the protector 68 and the second length L2 of the third region A3. The thus set lengths can prevent the waste liquid storing body 29 at the first position P1 from overlapping with the cover portion 66 in the loading direction Dm.
(5-6) The urging member 69 urges the protector 68 toward the protection position PP1. That is, for example, when the waste liquid storing body 29 is moved from the first position P1 to the second position P2, the protector 68 can be displaced to the protection position PP1 in conjunction with the movement of the waste liquid storing body 29. The waste liquid storing body 29 can therefore be readily loaded into the loading portion 28.

### Sixth Embodiment

A sixth embodiment of the recording apparatus and the waste liquid storing body will next be described with reference to the drawings. Note that the sixth embodiment differs from the fifth embodiment in terms of the protector. The other points in the sixth embodiment are substantially the same as those in the fifth embodiment, so that the same elements have the same reference characters, and no duplicated description thereof will be made.

### Waste Liquid Storing Body

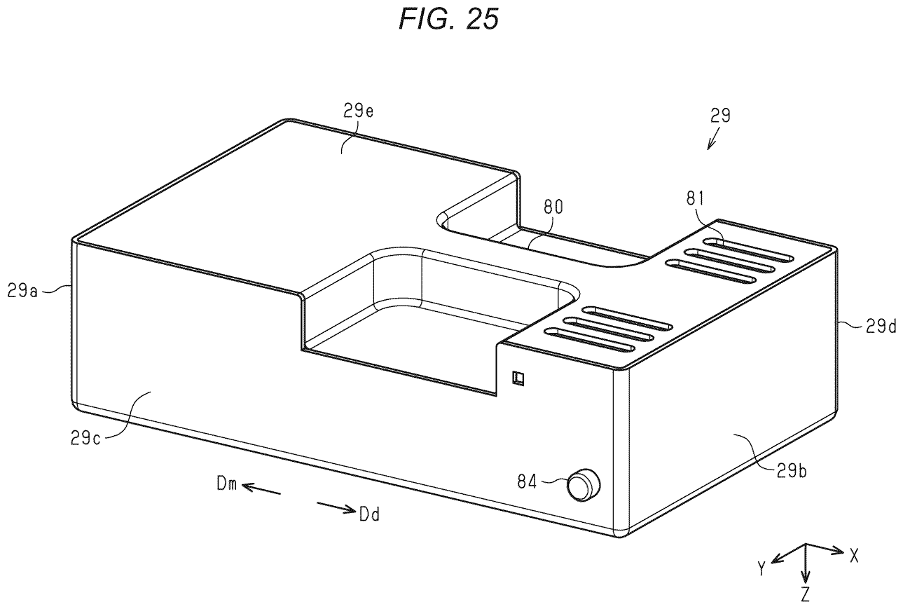

The waste liquid storing body 29 includes a boss 84, as shown in FIG. 25. The boss 84 is provided at the third side surface 29c. In the loaded posture, the boss 84 protrudes rearward in the depth direction Y from the third side surface 29c.

### Loading Portion

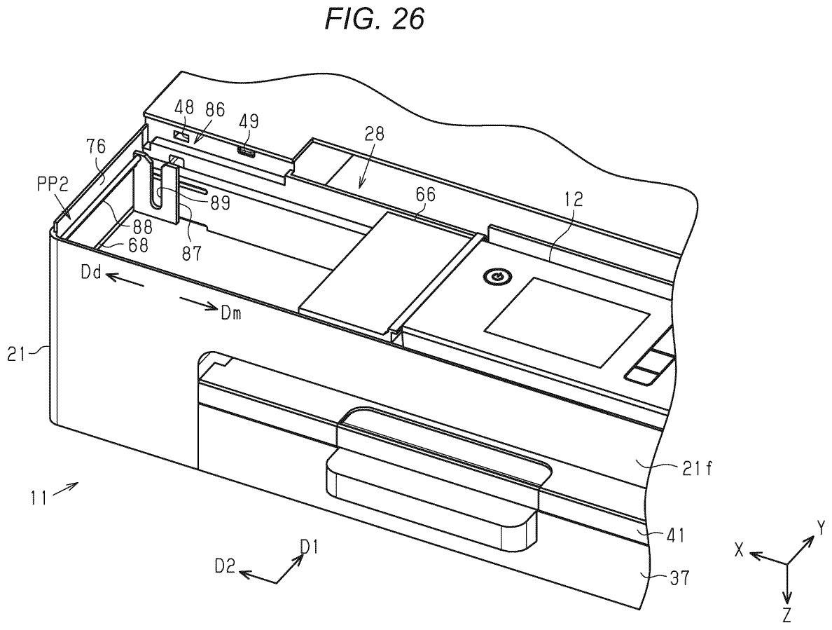

The loading portion 28 has a slide portion 86, as shown in FIG. 26. The slide portion 86 is movable in the loading direction Dm. The slide portion 86 is movable in the detachment direction Dd. The slide portion 86 may include a slider 87, a support shaft 88, and a groove 89. The groove 89 is formed in the slider 87. The groove 89 extends downward in the vertical direction Z from the upper end of the slider 87. The support shaft 88 is fixed to the slider 87. The support shaft 88 may extend in the first direction D1.

The protector 68 in the present embodiment is a sheet member. The protector 68 has flexibility. In the depth direction Y, the size of the protector 68 may be substantially equal to the size of the waste liquid storing body 29. In the depth direction Y, the size of the protector 68 may be substantially equal to the size of the third region A3. The protector 68 is provided at the slide portion 86. One end of the protector 68 is attached to the slide portion 86. The other end of the protector 68 is movable along the wall portion 76. The protector 68 is fixed to the support shaft 88. The one end of the protector 68 is movable along with the slide portion 86.

### Effects of Sixth Embodiment

Effects of the present embodiment will be described.

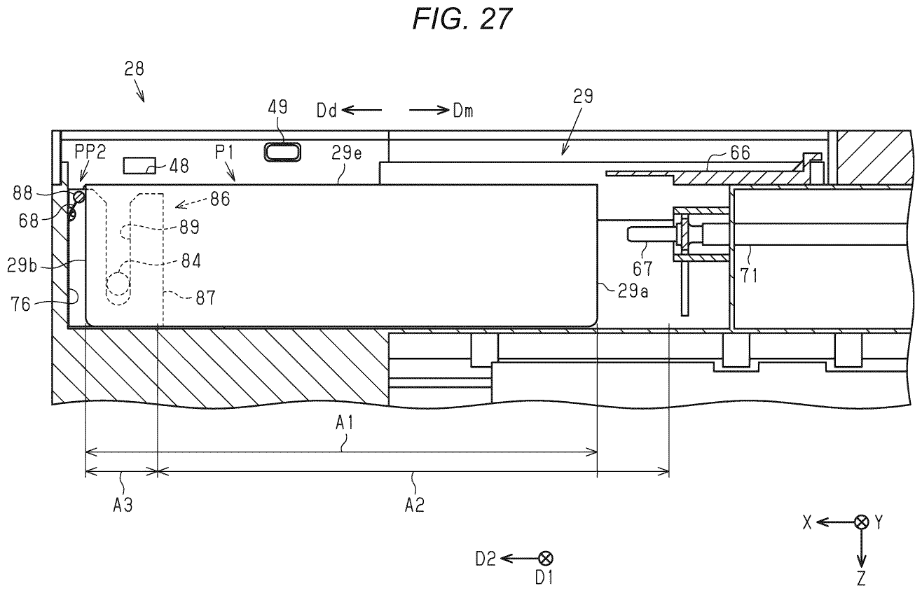

The slide portion 86 engages with the waste liquid storing body 29, as shown in FIG. 27. When the boss 84 enters the groove 89, the waste liquid storing body 29 engages with the slider 87. When the waste liquid storing body 29 is at the first position P1, the protector 68 is located at the retracted position PP2.

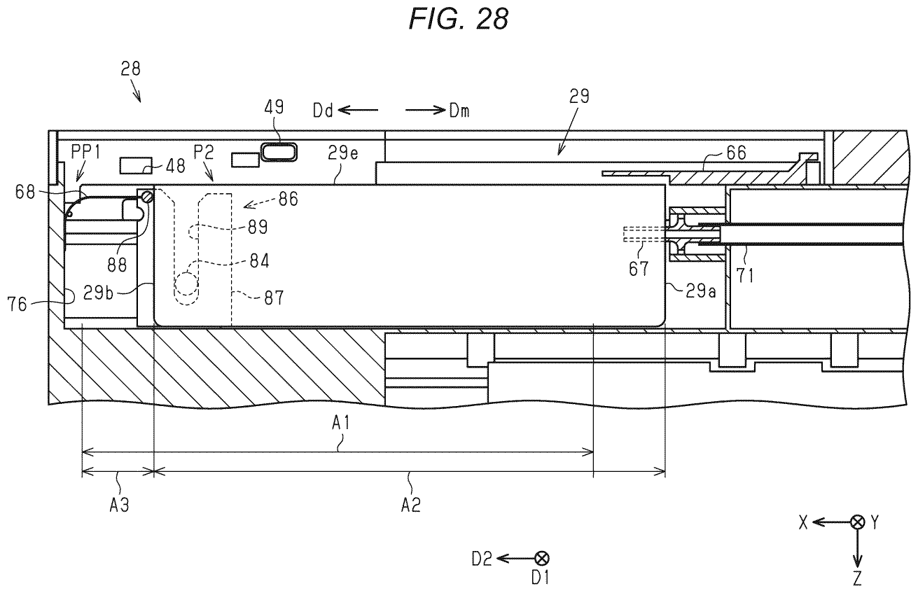

The slide portion 86 moves in the loading direction Dm along with the waste liquid storing body 29, as shown in FIG. 28. The slide portion 86 moving in the loading direction Dm pulls up the protector 68. When the waste liquid storing body 29 is at the second position P2, the protector 68 is located at the protection position PP1. The protector 68 located at the protection position PP1 covers at least a portion of the third region A3.

The slide portion 86 moves in the detachment direction Dd along with the waste liquid storing body 29, as shown in FIG. 27. When the slide portion 86 moves in the detachment direction Dd, the protector 68 lowers along the wall portion 76.

### Advantages of Sixth Embodiment

Advantages of the present embodiment will be described.
(6-1) The protector 68 is provided at the slide portion 86. The slide portion 86 moves along with the waste liquid storing body 29. The protector 68 can therefore be readily displaced in conjunction with the movement of the waste liquid storing body 29.
(6-2) The protector 68 is a sheet member. One end of the protector 68 is attached to the slide portion 86, and the other end thereof is movable. Therefore, when the slide portion 86 moves along with the waste liquid storing body 29, the protector 68 is pulled out and can cover the third region A3.

### Seventh Embodiment

A seventh embodiment of the recording apparatus and the waste liquid storing body will next be described with reference to the drawings. Note that the seventh embodiment differs from the fifth embodiment in terms of the protector. The other points in the seventh embodiment are substantially the same as those in the fifth embodiment, so that the same elements have the same reference characters, and no duplicated description thereof will be made. The recording apparatus 11 according to the present embodiment includes the waste liquid storing body 29.

### Waste Liquid Storing Body

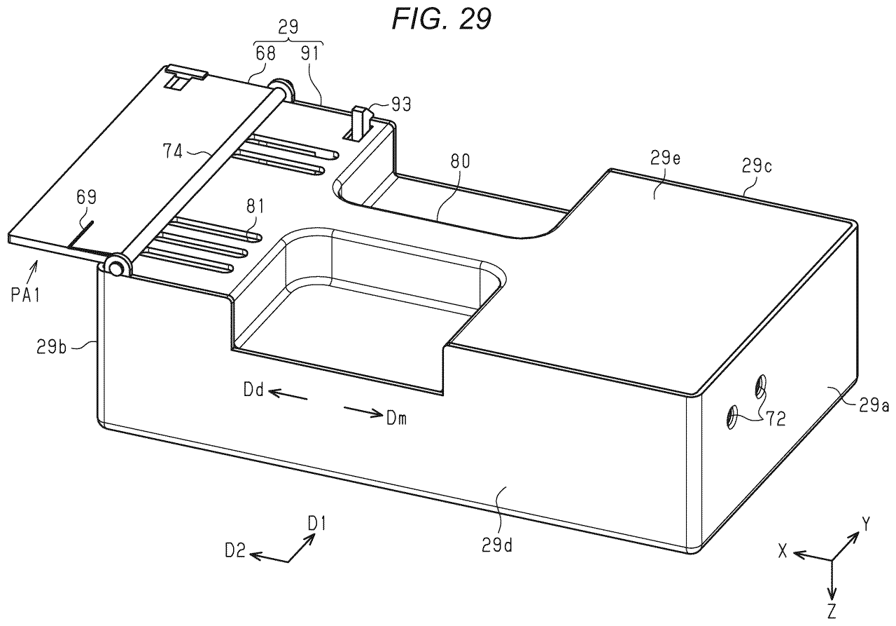

The waste liquid storing body 29 includes a main body 91 and the protector 68, as shown in FIG. 29. The waste liquid storing body 29 may include the urging member 69 and a restricting portion 93.

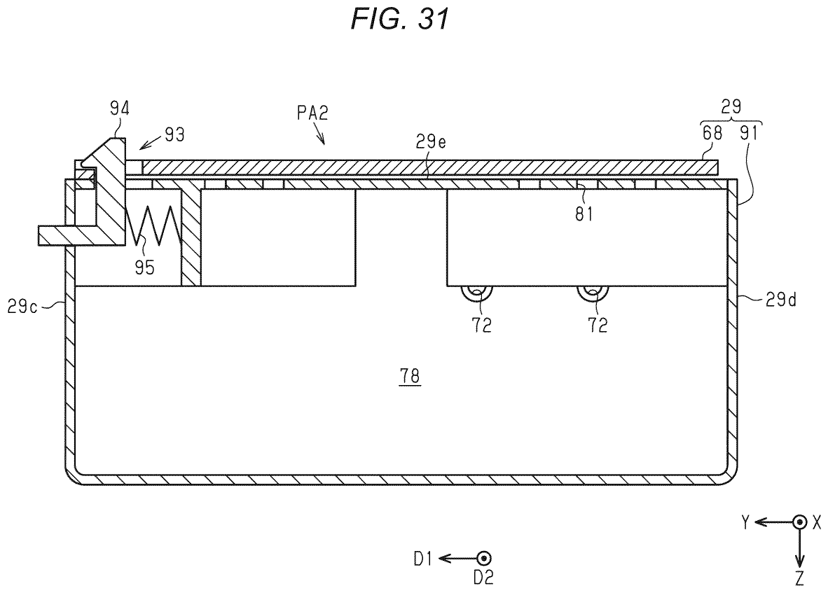

The main body 91 stores the waste liquid. The insertion port 72 is formed in the main body 91. The main body 91 may have multiple insertion ports 72. The main body 91 may have the storage chamber 78 shown in FIG. 31, the first side surface 29a, the second side surface 29b, the third side surface 29c, the fourth side surface 29d, and the top surface 29e. The opening 81 may be formed in the main body 91.

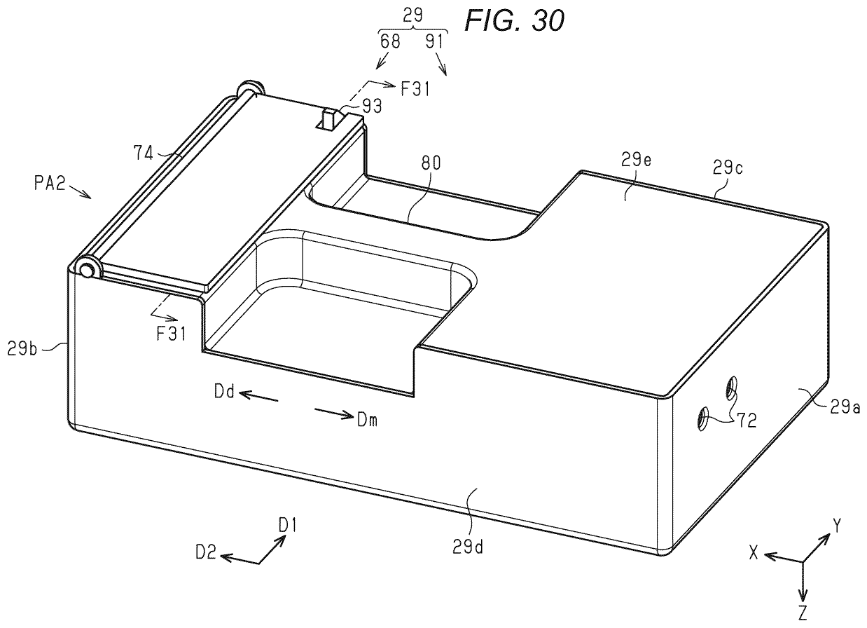

The protector 68 is part of the waste liquid storing body 29. The protector 68 is provided at the main body 91. The protector 68 is displaceable with respect to the main body 91. The protector 68 is displaceable to an overhanging position PA1 shown in FIG. 29 and a stored position PA2 shown in FIG. 30. The overhanging position PA1 is a position where the protector 68 overhangs from the main body 91. The stored position PA2 is a position where the amount of the overhang with respect to the main body 91 is smaller than that at the overhanging position PA1. The stored position PA2 may be a position where the protector 68 lies on the main body 91. The sentence “the amount of the overhang with respect to the main body 91 is smaller than that at the overhanging position PA1” includes a case where the protector 68 does not overhang from the main body 91.

The protector 68 is provided to be pivotable around the pivotal shaft 74, as shown in FIGS. 29 and 30. The pivotal shaft 74 may extend in the first direction D1. The protector 68 is displaceable to the overhanging position PA1 and the stored position PA2 when pivoting around the pivotal shaft 74. The protector 68 located at the stored position PA2 may cover the opening 81. The protector 68 located at the overhanging position PA1 may uncover the opening 81. The urging member 69 urges the protector 68 located at the stored position PA2 toward the overhanging position PA1. The urging member 69 pushes the protector 68 located at the stored position PA2.

The restricting portion 93 may include a hook 94 and a third spring 95, as shown in FIG. 31. The hook 94 may be provided to be displaceable in the depth direction Y in the loaded posture. The third spring 95 pushes the hook 94 rearward in the depth direction Y. A portion of the hook 94 pops out of the third side surface 29c. The hook 94 is caught by the protector 68 located at the stored position PA2. The restricting portion 93 restricts displacement of the protector 68 located at the stored position PA2.

### Loading Portion

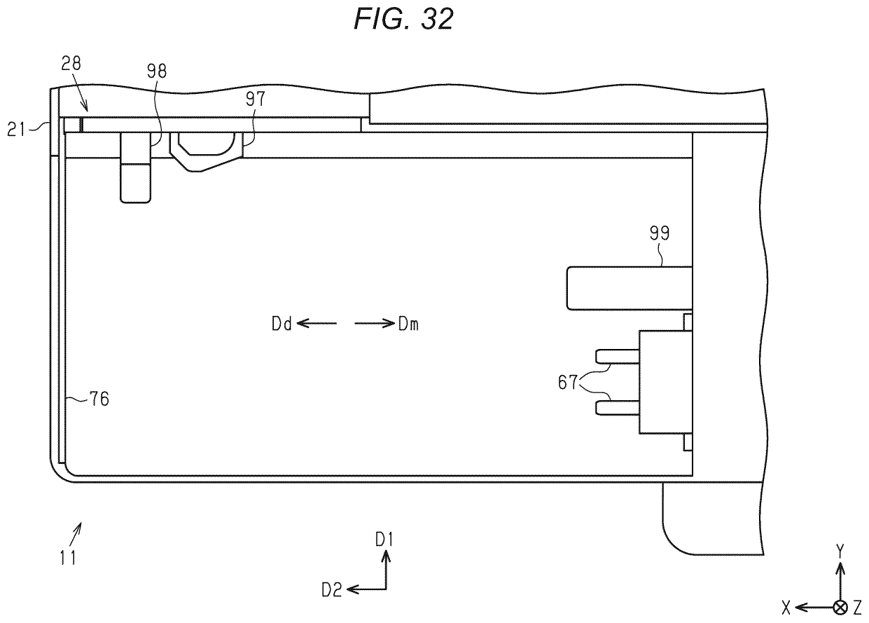

In FIGS. 32 to 35, the cover portion 66 is not shown.

The loading portion 28 may include multiple dischargers 67, as shown in FIG. 32. The loading portion 28 may include dischargers 67 the number of which is equal to the number of the insertion ports 72. The loading portion 28 may include a releasing portion 97, a first contact portion 98, and a second contact portion 99.

The releasing portion 97 and the first contact portion 98 protrude forward from the rear wall surface of the loading portion 28. The second contact portion 99 and the discharger 67 are arranged side by side in the depth direction Y. The releasing portion 97, the first contact portion 98, and the second contact portion 99 can come into contact with the waste liquid storing body 29.

### Effects of Seventh Embodiment

Effects of the present embodiment will be described.

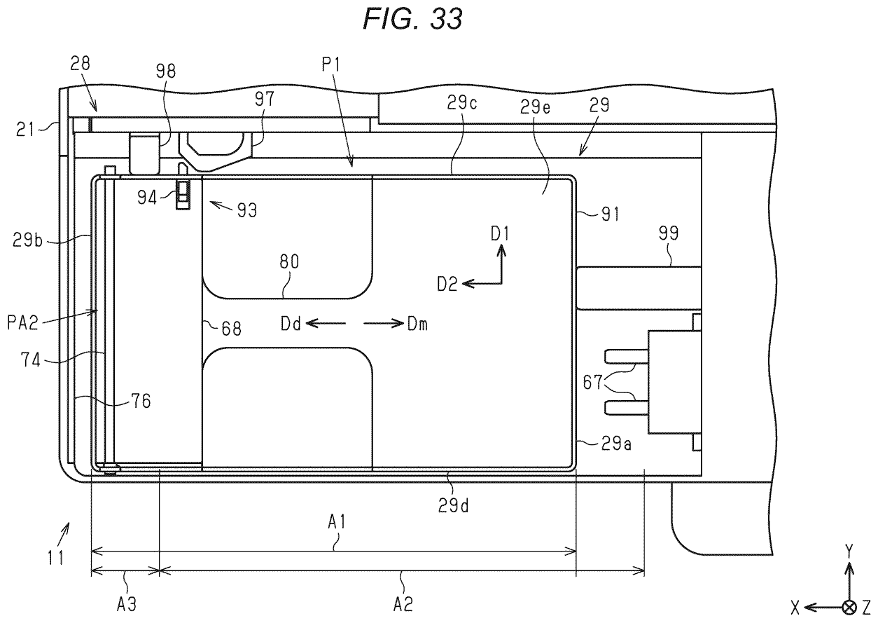

The waste liquid storing body 29 is inserted into the loading portion 28 in the state in which the protector 68 is located at the stored position PA2, as shown in FIG. 33. The waste liquid storing body 29 inserted into the loading portion 28 hits the first contact portion 98 to retract the first contact portion 98 rearward. When the waste liquid storing body 29 is at the first position P1, the first contact portion 98 comes into contact with the third side surface 29c. When the waste liquid storing body 29 is at the first position P1, the restricting portion 93 is located between the releasing portion 97 and the first contact portion 98 in the loading direction Dm.

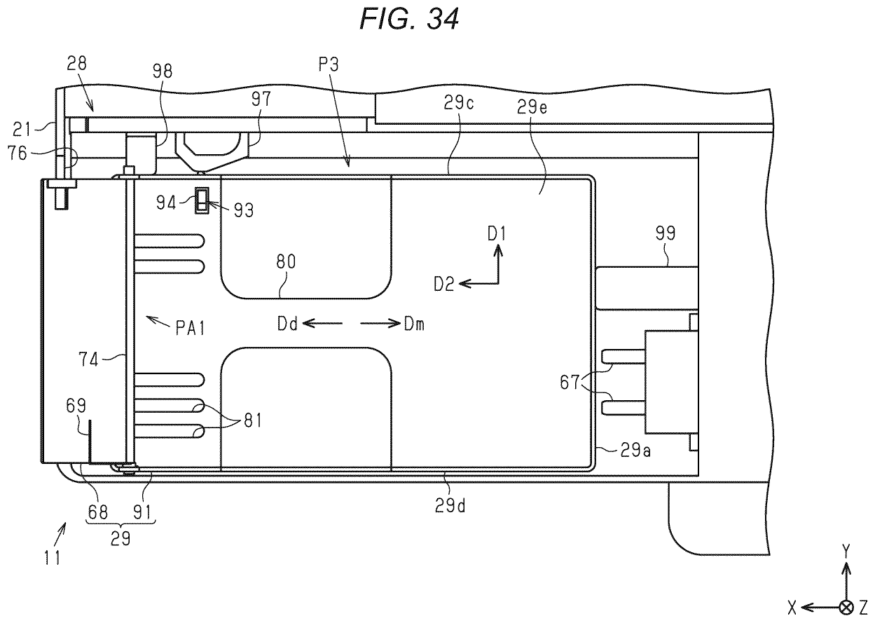

The restricting portion 93 hits the releasing portion 97 in the process of displacing the waste liquid storing body 29 from the first position P1 to the second position P2, as shown in FIG. 34. The releasing portion 97 moves the hook 94 forward to release the restriction of the protector 68. The restricting portion 93 releases the restriction of the protector 68 in the process of displacing the waste liquid storing body 29 from the first position P1 to the second position P2. The unrestricted protector 68 is urged by the urging member 69 to move to the overhanging position PA1.

An intermediate position P3 is a position between the first position P1 and the second position P2. When the waste liquid storing body 29 is at the intermediate position P3, the protector 68 is caught by the wall portion 76. Therefore, when the waste liquid storing body 29 is at the intermediate position P3, the first maintenance cover 31 moving from the non-cover position PC2 toward the cover position PC1 interferes with the protector 68 before moving to the cover position PC1.

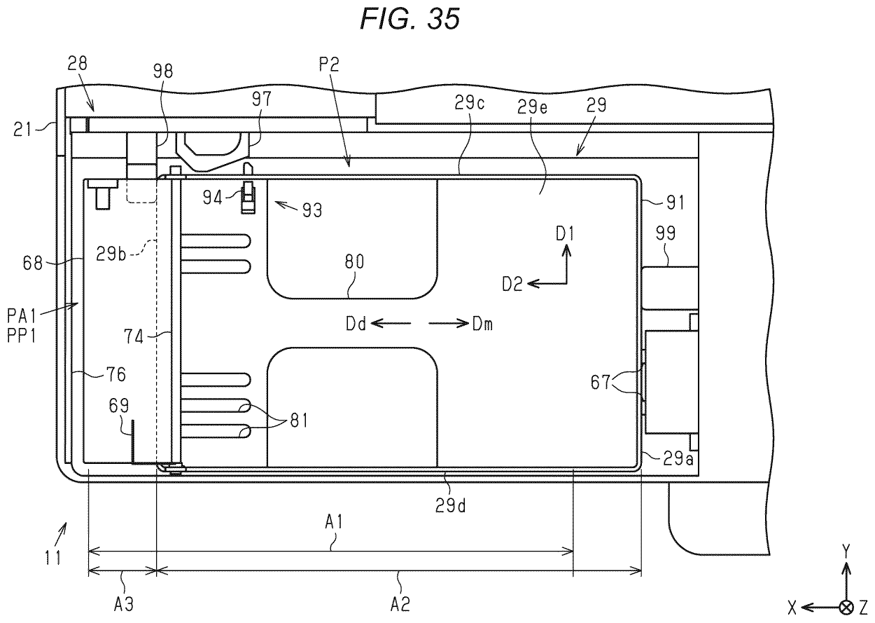

The waste liquid storing body 29 comes into contact with the second contact portion 99 in the process of being displacing to the second position P2, as shown in FIG. 35. The second contact portion 99 can come into contact with the first side surface 29a. The second contact portion 99 is pushed by the waste liquid storing body 29 to move in the loading direction Dm. The second contact portion 99 pushes the first side surface 29a in the detachment direction Dd. The second contact portion 99 may be longer than the second length L2, which is the length of the third region A3 in the loading direction Dm, and may be movable in the loading direction Dm.

When the waste liquid storing body 29 is at the second position P2, the first contact portion 98 comes into contact with the second side surface 29b. When the waste liquid storing body 29 is at the second position P2, the overhanging position PA1 coincides with the protection position PP1. When the waste liquid storing body 29 is at the second position P2, the protector 68 covers at least a portion of the third region A3. The distance between the first contact portion 98 and the wall portion 76 in the loading direction Dm may be smaller than the second length L2, which is the length of the third region A3 in the loading direction Dm.

### Advantages of Seventh Embodiment

Advantages of the present embodiment will be described.
(7-1) For example, when the protector 68 is provided at the loading portion 28, to position the waste liquid storing body 29 at the first position P1 from outside, the protector 68 may have to be retracted. In this regard, the protector 68 is provided at the waste liquid storing body 29. A concern that the protector 68 hinders the attachment of the waste liquid storing body 29 can therefore be reduced.
(7-2) The protector 68 is pivotable around the pivotal shaft 74 extending in the first direction D1. Causing the protector 68 to pivot allows the protector 68 to be readily displaced to the stored position PA2 and the overhanging position PA1.
(7-3) When the waste liquid storing body 29 is displaced from the first position P1 to the second position P2, the restricting portion 93 releases the restriction of the protector 68. That is, the protector 68 is pivotable around the pivotal shaft 74. The protector 68 located at the stored position PA2 is urged by the urging member 69 toward the overhanging position PA1. The protector 68 can therefore be displaced to the overhanging position PA1 in conjunction with the displacement of the waste liquid storing body 29.
(7-4) The protector 68 located at the overhanging position PA1 uncovers the opening 81, which can facilitate evaporation of the waste liquid. The protector 68 located at the stored position PA2 covers the opening 81, which can reduce a concern that the waste liquid leaks via the opening 81.
(7-5) The first maintenance cover 31 covers the loading portion 28. Inadvertent access to the waste liquid storing body 29 loaded into the loading portion 28 can therefore be suppressed.
(7-6) The first contact portion 98 comes into contact with different surfaces of the waste liquid storing body 29 in accordance with the position of the waste liquid storing body 29. For example, when the user displaces the waste liquid storing body 29 located at the first position P1 to the second position P2, the first contact portion 98 comes into contact with a different surface, allowing the user to feel a click sensation. The user is thus notified that the waste liquid storing body 29 has been displaced to the second position P2, so that failure of the operation of loading the waste liquid storing body 29 can be suppressed.
(7-7) The loading portion 28 includes the second contact portion 99. The waste liquid storing body 29 is pushed in the detachment direction Dd when coming into contact with the second contact portion 99. The first contact portion 98 having come into contact with the second side surface 29b prevents the waste liquid storing body 29 displaced to the second position P2 from being displaced in the detachment direction Dd. Therefore, even when the waste liquid storing body 29 displaced to the second position P2 is pushed by the second contact portion 99, the waste liquid storing body 29 stays at the second position P2. However, when the user releases his/her hand from the waste liquid storing body 29 before displacing the waste liquid storing body 29 to the second position P2, the waste liquid storing body 29 is displaced in the detachment direction Dd. The user can therefore notice that the waste liquid storing body 29 has not been loaded.
(7-8) In the state in which the waste liquid storing body 29 is located at the intermediate position P3, the first maintenance cover 31 interferes with the protector 68 and cannot therefore close the loading portion 28. The user can therefore notice that the waste liquid storing body 29 has not been loaded.

### Eighth Embodiment

An eighth embodiment of the recording apparatus and the waste liquid storing body will next be described with reference to the drawings. Note that the eighth embodiment differs from the fifth embodiment in terms of the protector. The other points in the eighth embodiment are substantially the same as those in the fifth embodiment, so that the same elements have the same reference characters, and no duplicated description thereof will be made. The recording apparatus 11 according to the present embodiment includes the waste liquid storing body 29.

### Waste Liquid Storing Body

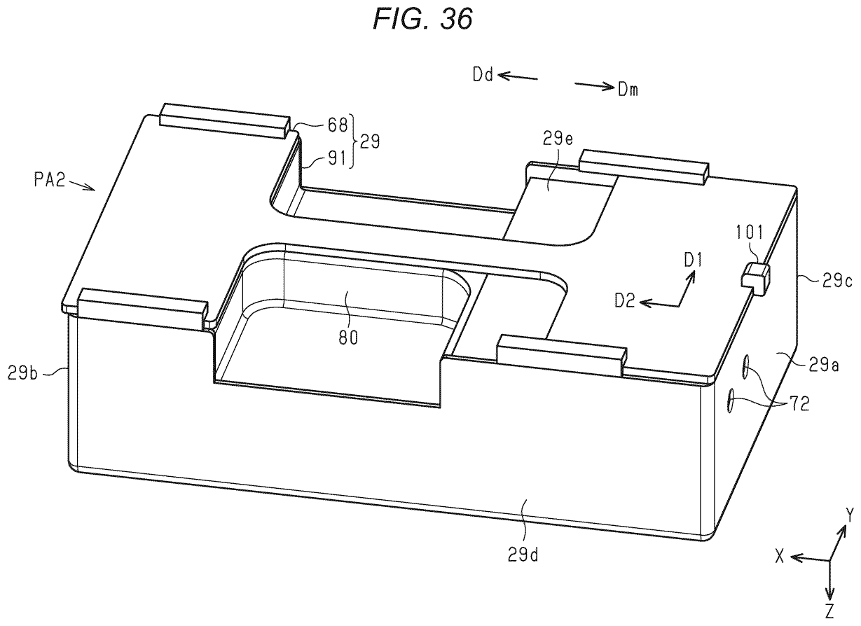

The waste liquid storing body 29 includes the main body 91 and the protector 68, as shown in FIG. 36.

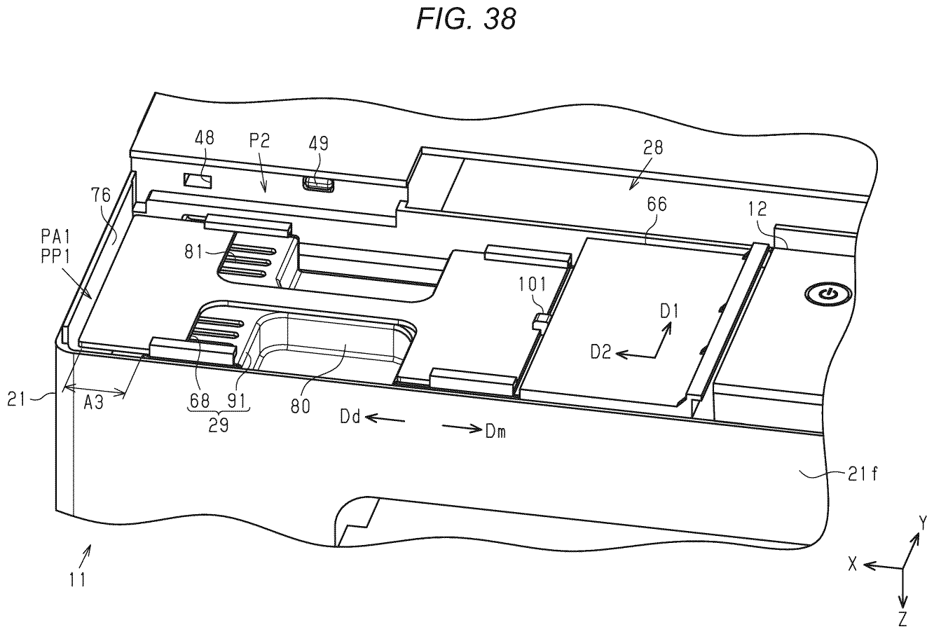

The protector 68 is part of the waste liquid storing body 29. The protector 68 is displaceable with respect to the main body 91. The protector 68 is slidable with respect to the main body 91. The protector 68 is slidable with respect to the main body 91 in the loading direction Dm and the detachment direction Dd. The protector 68 is displaceable to the overhanging position PA1 shown in FIG. 38 and the stored position PA2 shown in FIG. 36. The protector 68 located at the stored position PA2 covers the opening 81. The protector 68 located at the overhanging position PA1 uncovers the opening 81. The protector 68 may have a protruding portion 101. The protruding portion 101 may be located at the tip of the protector 68 in the loading direction Dm. The protruding portion 101 may protrude upward in the vertical direction Z in the loaded posture. The protruding portion 101 may protrude in the loading direction Dm.

### Loading Portion

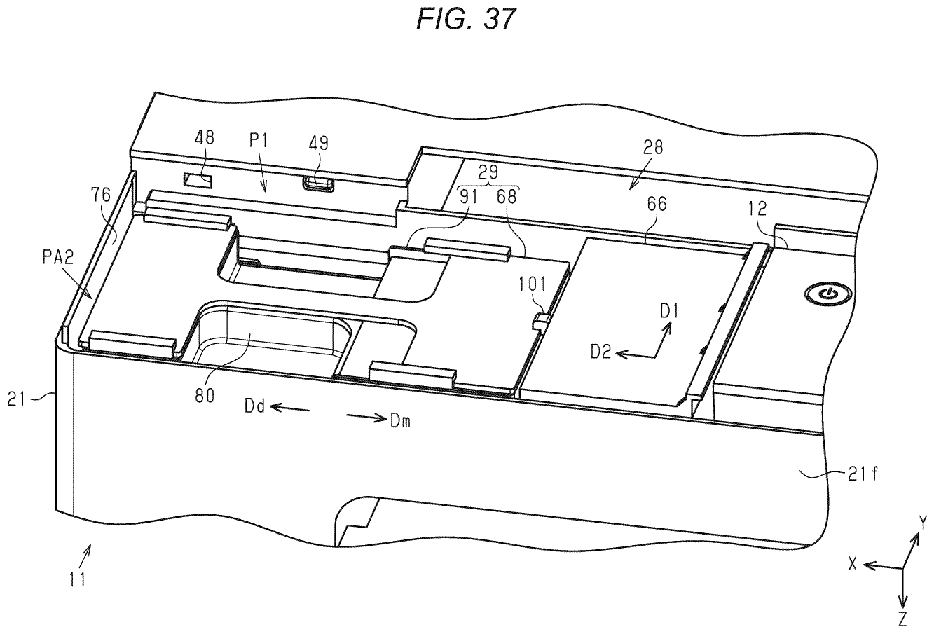

The loading portion 28 includes the cover portion 66, which is an example of an interference portion, as shown in FIG. 37. The cover portion 66 interferes with the protector 68 when the waste liquid storing body 29 is displaced in the loading direction Dm. The cover portion 66 may interfere with the protruding portion 101 when the waste liquid storing body 29 is displaced in the loading direction Dm.

### Effects of Eighth Embodiment

Effects of the present embodiment will be described.

The waste liquid storing body 29 is inserted into the loading portion 28 in the state in which the protector 68 is located at the stored position PA2, as shown in FIG. 37. When the waste liquid storing body 29 is at the first position P1, the protector 68 is located at the stored position PA2.

The cover portion 66 interferes with the protector 68 in the process of displacing the waste liquid storing body 29 from the first position P1 to the second position P2 in the loading direction Dm. In the waste liquid storing body 29 displaced from the first position P1 in the loading direction Dm, the protector 68 hits the cover portion 66, so that the displacement of the protector 68 is restricted, whereas the main body 91 is so displaced that it enters the space below the cover portion 66. In the waste liquid storing body 29, the main body 91 moves in the loading direction Dm, whereas the protector 68 is stationary. The cover portion 66 displaces the protector 68 to the overhanging position PA1 by moving the protector 68 with respect to the main body 91. In the present embodiment, the state in which the main body 91 is located at the first position P1 is referred to as the state in which the waste liquid storing body 29 is located at the first position P1.

In the present embodiment, the state in which the main body 91 is located at the second position P2 is referred to as the state in which the waste liquid storing body 29 is located at the second position P2.

When the waste liquid storing body 29 is at the second position P2, the protector 68 is located at the overhanging position PA1, as shown in FIG. 38. When the waste liquid storing body 29 is at the second position P2, the overhanging position PA1 coincides with the protection position PP1. When the waste liquid storing body 29 is at the second position P2, the protector 68 covers at least a portion of the third region A3.

The protector 68 interferes with the wall portion 76 in the process of displacing the waste liquid storing body 29 from the second position P2 to the first position P1 in the detachment direction Dd. That is, the wall portion 76 interferes with the protector 68 in the process of displacing the waste liquid storing body 29 from the second position P2 to the first position P1 in the detachment direction Dd. In the waste liquid storing body 29 displaced from the second position P2 in the detachment direction Dd, the protector 68 hits the wall portion 76, so that the displacement of the protector 68 is restricted, whereas the main body 91 is displaced in the detachment direction Dd. The wall portion 76 moves the protector 68 with respect to the main body 91 to displace the protector 68 to the stored position PA2.

### Advantages of Eighth Embodiment

Advantages of the present embodiment will be described.
(8-1) The protector 68 is slidable with respect to the main body 91. A space necessary for displacing the protector 68 with respect to the main body 91 can therefore be reduced.
(8-2) The cover portion 66 can interfere with the protector 68. The cover portion 66 moves the protector 68 with respect to the main body 91 when interfering with the protector 68 in the process of displacing the waste liquid storing body 29 in the loading direction Dm. The protector 68 can therefore be displaced to the overhanging position PA1 in conjunction with the displacement of the waste liquid storing body 29.
(8-3) The wall portion 76 can interfere with the protector 68. The wall portion 76 moves the protector 68 with respect to the main body 91 when interfering with the protector 68 in the process of displacing the waste liquid storing body 29 in the detachment direction Dd. The protector 68 can therefore be displaced to the stored position PA2 in conjunction with the displacement of the waste liquid storing body 29.

### Ninth Embodiment

A ninth embodiment of the recording apparatus and the waste liquid storing body will next be described with reference to the drawings. Note that the ninth embodiment differs from the sixth embodiment in terms of the protector. The other points in the ninth embodiment are substantially the same as those in the sixth embodiment, so that the same elements have the same reference characters, and no duplicated description thereof will be made.

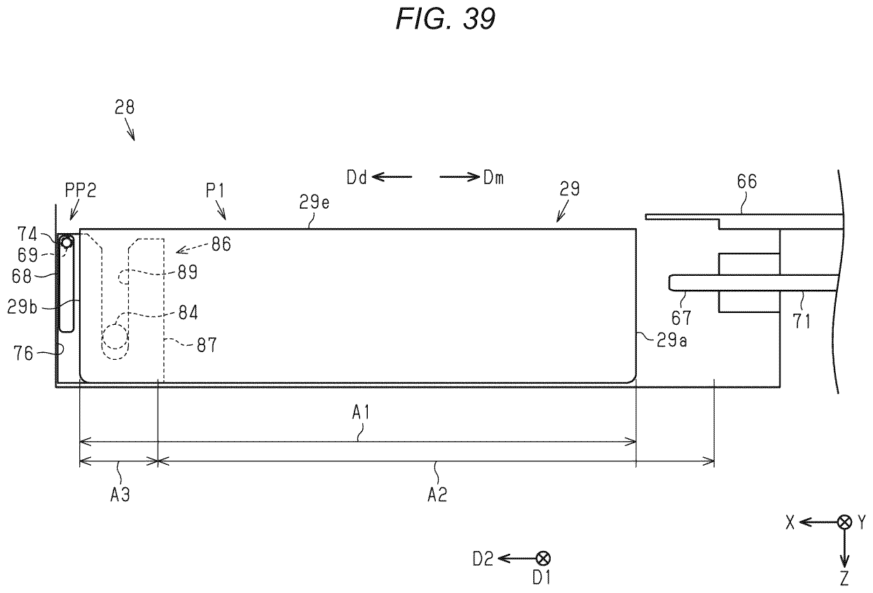

The slide portion 86 may include the slider 87, the protector 68, and the urging member 69, as shown in FIG. 39. The protector 68 may be provided to be pivotable around the pivotal shaft 74. The slider 87 may support the pivotal shaft 74.

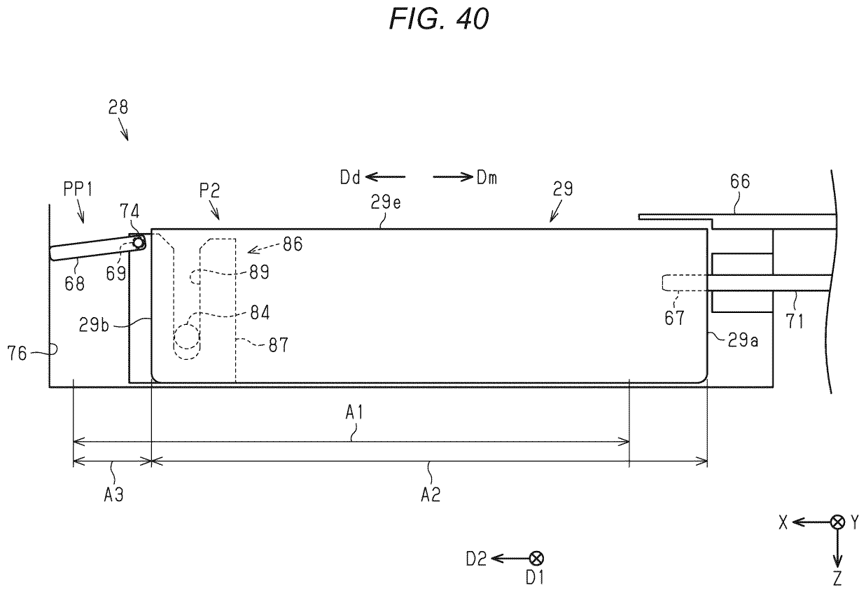

The protector 68 is displaceable to the protection position PP1 shown in FIG. 40 and the retracted position PP2 shown in FIG. 39. The urging member 69 may push the protector 68 located at the retracted position PP2 toward the protection position PP1.

### Effects of Ninth Embodiment

Effects of the present embodiment will be described.

When the boss 84 enters the groove 89, the waste liquid storing body 29 engages with the slide portion 86, as shown in FIG. 39. When the waste liquid storing body 29 is at the first position P1, the protector 68 is located at the retracted position PP2.

The slide portion 86 moves in the loading direction Dm along with the waste liquid storing body 29, as shown in FIG. 40. When the slide portion 86 moves in the loading direction Dm, the urging member 69 pushes up the protector 68. When the waste liquid storing body 29 is at the second position P2, the protector 68 is located at the protection position PP1. The protector 68 located at the protection position PP1 covers at least a portion of the third region A3.

### Variations

The embodiments described above can be changed and implemented as described below. The embodiments described above and the variations described below can be implemented in combination with each other as long as no technical inconsistencies are involved.

When the detector 23 detects that the reading unit 13 is not located at the reading position PR1, the controller 22 may prohibit recording.

At least a portion of the second maintenance cover 32 located at the closed position may overlap with the reading unit 13 located at the reading position PR1. When the reading unit 13 is located at the reading position PR1, displacement of the second maintenance cover 32 from the closed position to the open position may be restricted. When the reading unit 13 is located at the non-reading position PR2, displacement of the second maintenance cover 32 from the closed position to the open position may be allowed.

The recording apparatus 11 may include a second cover separately from the reading unit 13. The second cover may not contain the reader 17. For example, the recording apparatus 11 may include a second cover that is opened and closed when a medium 19 jammed during the conveyance is removed. The second cover may overlap with at least a portion of the first maintenance cover 31 or at least a portion of the operation portion 53. The second cover may be located forward of the first maintenance cover 31 in the depth direction Y.

The detector 23 may detect the position of the operation portion 53. The detector 23 may detect that the engager 54 has engaged with the engagement receiver 48.

When the first maintenance cover 31 is located at the cover position PC1, and the reading unit 13 is located at the reading position PR1, the operation portion 53 may be located at a position where the operation portion 53 does not overlap with the reading unit 13.

The first maintenance cover 31 located at the cover position PC1 may not overlap with the reading unit 13 located at the reading position PR1. The first maintenance cover 31 may be displaceable to the cover position PC1 and the non-cover position PC2 while the reading unit 13 is located at the reading position PR1.

In the third and fourth embodiments, the pusher 49 may push the first maintenance cover 31 in the direction opposite the first direction D1.

In the first embodiment, the loading portion 28 may not include the pusher 49.

The recording apparatus 11 may include multiple loading portions 28.

The recording apparatus 11 may include a loading portion 28 into which the liquid storing body 24 can be loaded. The liquid storing body 24 may be an example of the loaded member. The second maintenance cover 32 may be an example of the cover and the first cover. The second maintenance cover 32 may include the operation portion 53 and the engager 54.

The medium storing portion 37 may be an example of the loaded member. The recording apparatus 11 may include a cover that covers the medium storing portion 37.

Multiple loaded members may be loaded into one loading portion 28. For example, the liquid storing body 24 and the waste liquid storing body 29 may be loadable into the loading portion 28.

A toner cartridge, which is an example of the loaded member, may be loadable into the loading portion 28. The toner cartridge may store toner used to perform recording.

A toner box, which is an example of the loaded member, may be loadable into the loading portion 28. The toner box may store collected toner.

The recording apparatus 11 may include multiple protectors 68. The recording apparatus 11 may include at least two of the protector 68 provided at the loading portion 28, the protector 68 provided at the slide portion 86, and the protector 68 provided at the waste liquid storing body 29. Covering the third region A3 with multiple protectors 68 allows reduction in the size of each of the protectors 68.

In the eighth embodiment, the protruding portion 101 may be provided at the cover portion 66. The protruding portion 101 provided at the cover portion 66 may interfere with the protector 68 when the waste liquid storing body 29 is displaced in the loading direction Dm.

In the sixth embodiment, the protector 68 may have one end attached to the support shaft 88, and another end attached to the wall portion 76. The protector 68 may move to the protection position PP1, where the protector 68 is stretched, and the retracted position PP2, where the protector 68 is loosened.

In the fifth to ninth embodiments, the recording apparatus 11 may not include the first maintenance cover 31.

The first maintenance cover 31 in each of the fifth to ninth embodiments does not necessarily have the configuration described in the first to fourth embodiments. In the fifth to ninth embodiments, the first maintenance cover 31 only needs to cover the loading portion 28 in the state in which the first maintenance cover 31 is located at the cover position PC1.

The opening 81 may open irrespective of the position of the protector 68.

The opening 81 may partially open irrespective of the position of the protector 68.

The cover portion 66 in each of the embodiments may have the first mark 70. The waste liquid storing body 29 in each of the embodiments may have the second mark 82. The loading portion 28 in each of the embodiments may include the first contact portion 98. The loading portion 28 in each of the embodiments may include the second contact portion 99. For example, when the waste liquid storing body 29 is insufficiently loaded, there is a concern that the waste liquid leaks from the discharger 67. In this regard, providing the first mark 70 and the second mark 82, and the first contact portion 98 or the first contact portion 98 and the second contact portion 99 allows the user to recognize that the waste liquid storing body 29 has been insufficiently loaded.

The first length L1 of the protector 68 may be equal to the second length L2 of the third region A3. The first length L1 may be shorter than the second length L2.

The third length L3 may be equal to at least one of the first length L1 and the second length L2. The third length L3 may be longer than at least one of the first length L1 and the second length L2.

In the protector 68 provided at the loading portion 28, the pivotal shaft 74 may extend in a direction different from the first direction D1. For example, the pivotal shaft 74 may extend in the second direction D2.

The protector 68 may be moved by the user. The user may position the protector 68 at the retracted position PP2, and then position the waste liquid storing body 29 at the first position P1. The user may position the waste liquid storing body 29 at the second position P2, and then position the protector 68 at the protection position PP1. The user may displace the waste liquid storing body 29 in the state in which the protector 68 is positioned at the stored position PA2. For example, in the seventh embodiment, the releasing portion 97 may not be provided. In the seventh embodiment, a portion of the hook 94 may not pop out of the third side surface 29c. For example, in the eighth embodiment, the cover portion 66 may not interfere with the protector 68 when the waste liquid storing body 29 is displaced in the loading direction Dm.

In the ninth embodiment, the slide portion 86 may not include the urging member 69. In this case, the protector 68 may pivot when hitting the wall portion 76.

In the ninth embodiment, the pivotal shaft 74 may be provided at one end of the protector 68, and the other end of the protector 68 may be provided to be pivotable with respect to the wall portion 76.

The protector 68 located at the protection position PP1 may cover the entire third region A3. The protector 68 located at the protection position PP1 may cover a portion of the third region A3.

The recording apparatus 11 is not limited to an inkjet printer, and may be a laser printer, a thermal printer, a dot impact printer, a digital printing machine, or the like.

The recording apparatus may be a liquid spraying apparatus that sprays or ejects liquid other than ink to perform recording. The state of the liquid ejected in the form of a very small amount of droplets from the liquid spraying apparatus includes a particle state, a tear-drop state, and a thread state having a trailing end. The liquid mentioned herein may be any material that can be sprayed from the liquid spraying apparatus. For example, the liquid only needs to be a substance in a liquid phase, and includes high- or low-viscosity liquid, sol, gel water, other inorganic solvents, organic solvents, solutions, and fluid substances such as liquid resin, liquid metal, and metal melt. The liquid includes not only liquid as one state of a substance but also functional material particles made of solid matter such as pigment or metal particles and dissolved, dispersed, or mixed in a solvent. Representative examples of the liquid may include the ink described in the aforementioned embodiments, a liquid crystal, and the like. It is assumed that the term “ink” includes various types of liquid composition such as typical water-based ink, oil-based ink, gel ink, and hot melt ink. Specific examples of the liquid spraying apparatus include an apparatus that sprays liquid containing a material in a dispersed or dissolved form, the material being, for example, an electrode material or a coloring material used, for example, to manufacture a liquid crystal display, an electroluminescence display, a surface-emitting display, and a color filter. The liquid spraying apparatus may be an apparatus that sprays a bioorganic substance used to manufacture a biochip, an apparatus that is used as a precision pipette and sprays liquid serving as a sample, a textile printing apparatus, a micro dispenser, or the like. The liquid spraying apparatus can be an apparatus that sprays lubricating oil to a precision machine such as a timepiece and a camera in a pinpoint manner, or an apparatus that sprays transparent resin liquid such as ultraviolet curable resin onto a substrate in order to form a minute hemispherical lens, an optical lens, or the like used for an optical communication element or the like. The liquid spraying apparatus may be an apparatus that sprays an acid or alkali etching solution or the like in order to etch a substrate or the like.

### Definitions

The expression “at least one” used in the present specification means “one or more” of desired candidates. For example, the expression “at least one” used in the present specification means “only one candidate” or “both of two candidates” when the number of candidates is two. As another example, the expression “at least one” used in the present specification means “only one candidate”, “the combination of any two candidates”, or “the combination of any three or more candidates” when the number of candidates is three or more.

### Additional Remarks

Technical ideas grasped from the embodiments and variations described above, and the effects and advantages thereof will be described below.
[1] A recording apparatus includes a recording portion configured to perform recording on a medium; a loading portion having a loading space into which a loaded member is loadable; and a cover displaced from a non-cover position at which the cover does not cover the loading space to a cover position at which the cover covers the loading space when caused to slide in a first direction, and displaced from the cover position to the non-cover position when caused to slide in a direction opposite the first direction, the cover includes an operation portion movable in the first direction and the direction opposite the first direction when externally operated, and an engager engageable with an engagement receiver provided in the loading portion, and the engager moves to an engagement position at which the engager is engageable with the engagement receiver when the operation portion is moved in the first direction and is located at a non-engagement position at which the engager is not engageable with the engagement receiver when the operation portion is moved in the direction opposite the first direction.

According to the configuration described above, when the operation portion is moved in the direction opposite the first direction, the engager moves to the non-engagement position. That is, when the operation portion is moved in the direction opposite the first direction, the engager disengages from the engagement receiver, so that the cover becomes movable. The cover is displaced to the non-covering position when caused to slide in the direction opposite the first direction. The configuration in which the direction in which the user operates the operation portion is the same as the direction in which the cover is caused to slide improves the user's operability of the operation portion and the cover.
[2] A recording apparatus includes a recording portion configured to perform recording on a medium; a loading portion having a loading space into which a loaded member is loadable; and a cover displaced from a non-cover position at which the cover does not cover the loading space to a cover position at which the cover covers the loading space when caused to slide in a first direction, and displaced from the cover position to the non-cover position when caused to slide in a direction opposite the first direction, the cover includes an operation portion movable to a locked position and an unlocked position when externally operated, and an engager engageable with an engagement receiver provided in the loading portion, the engager is located at an engagement position at which the engager is engageable with the engagement receiver when the operation portion is located at the locked position and is located at a non-engagement position at which the engager is not engageable with the engagement receiver when the operation portion is located at the unlocked position, and the loading portion includes a pusher urged in the direction opposite the first direction and configured to push the cover located at the cover position.

According to the configuration described above, the pusher pushes the cover located at the cover position toward the non-cover position. Therefore, when the engager disengages from the engagement receiver, the cover moves in the direction opposite the first direction. The direction in which the cover is detached is therefore readily known, so that the user's operability of the cover can be improved.
[3] In the recording apparatus according to [2] described above, the operation portion may move to the locked position when moved in a second direction different from the first direction, and to the unlocked position when moved in a direction opposite the second direction.

The configuration described above, in which the pusher pushes the cover, allows the user to readily know the direction in which the cover is detached. Therefore, even when the direction in which the operation portion is moved differs from the direction in which the cover is caused to slide, a concern that the user is confused at how to detach the cover can be reduced. The operation portion can therefore be configured with increased flexibility.
[4] In the recording apparatus according to [1] or [2] described above, the engager may move to the engagement position and the non-engagement position when moved in the first direction and the direction opposite the first direction, respectively.

According to the configuration described above, the engager moves in the same direction as the operation portion. The force with which the user operates the operation portion can therefore be used as it is to move the engager. Loss of the operation force can therefore be reduced.
[5] In the recording apparatus according to [1] or [2] described above, the engager may move to the engagement position and the non-engagement position when moved in a second direction different from the first direction and a direction opposite the second direction, respectively.

According to the configuration described above, the engager moves in a direction different from the direction in which the cover is caused to slide. Therefore, even when a force acts on the cover in the state in which the engager engages with the engagement receiver, the cover is unlikely to move.
[6] In the recording apparatus according to [1] or [2] described above, the engager may move to the engagement position and the non-engagement position when caused to pivot.

According to the configuration described above, the engager pivots. The engager can therefore be moved with a small force as compared, for example, with a case where the engager is caused to slide.
[7] In the recording apparatus according to [1] or [2] described above, the cover moving from the non-cover position in the first direction in a state in which the engager is located at the engagement position may interfere with the loading portion before moving to the cover position.

According to the configuration described above, in the state in which the engager is located at the engagement position, the engager interferes with the loading portion. The cover cannot therefore be displaced to the cover position. A concern that the cover is erroneously attached can therefore be reduced.
[8] In the recording apparatus according to any one of [1] to [7] described above, the cover is called a first cover, the cover position is called a first cover position, and the non-cover position is called a first non-cover position, the recording apparatus may further include a second cover, the second cover may be displaceable to a second cover position at which the second cover covers an interior of the apparatus and a second non-cover position at which the second cover does not cover the interior of the apparatus, at least a portion of the first cover located at the first cover position may overlap with at least a portion of the second cover located at the second cover position, and the second cover may be located above the first cover.

According to the configuration described above, the second cover located at the second cover position is located above the first cover and overlaps with the first cover. A concern that the first cover is inadvertently detached can therefore be reduced.
[9] In the recording apparatus according to [8] described above, when the first cover is located at the first cover position and the second cover is located at the second cover position, at least a portion of the operation portion may overlap with the second cover.

According to the configuration described above, the second cover located at the second cover position overlaps with the operation portion of the first cover located at the first cover position. A concern that the user inadvertently moves the operation portion can therefore be reduced.
[10] In the recording apparatus according to [8] or [9] described above, in a state in which the first cover is located at the first cover position and the operation portion is located at an unlocked position, the second cover moving from the second non-cover position to the second cover position may interfere with the operation portion before moving to the second cover position.

According to the configuration described above, in the state in which the operation portion is located at the unlocked position, the second cover interferes with the operation portion, so that the second cover cannot be displaced to the second cover position. A concern that the operation portion located at the unlocked position is used can therefore be reduced.
[11] The recording apparatus according to any one of [8] to [10] described above may further include a detector configured to detect whether the second cover is open or closed.

According to the configuration described above, the detector detects whether the second cover is open or closed. A concern that the second cover not located at the second cover position is used can therefore be reduced.
[12] In the recording apparatus according to any one of [8] to [11] described above, the second cover may include a reader configured to read an image of a document.

According to configuration described above, the second cover includes the reader. The size of the apparatus can therefore be reduced as compared with a case where the reader is separately provided.
[13] The recording apparatus according to any one of [1] to [12] described above may further include a maintenance portion configured to perform maintenance of the recording portion, the recording portion may be a liquid ejector configured to eject liquid, and the loaded member may be a waste liquid storing body configured to store waste liquid collected by the maintenance portion.

According to configuration described above, the cover covers the waste liquid storing body. The operability of the cover is improved as described in [1]. A concern that it takes time for the user to detach the cover so that the user inadvertently touches the waste liquid storing body can therefore be reduced.
[14] A recording apparatus according to an aspect of the present disclosure includes: a recording portion configured to perform recording by ejecting liquid onto a medium, waste liquid discharged from the recording portion being stored in a waste liquid storing body; a discharger inserted into an insertion port of the waste liquid storing body and configured to discharge the waste liquid into the waste liquid storing body; a loading portion into which the waste liquid storing body is loaded when the waste liquid storing body is displaced in a loading direction from a first position where the discharger is not inserted into the insertion port to a second position where the discharger is inserted into the insertion port; and a displaceable protector, a region occupied by the waste liquid storing body located at the first position is called a first region, a region occupied by the waste liquid storing body located at the second position is called a second region, a region that does not overlap with the second region out of the first region is called a third region, the protector is located at a protection position where the protector covers at least a portion of the third region when the waste liquid storing body is at the second position, and the protector is retracted from the protection position when the waste liquid storing body is at the first position.

According to the configuration described above, the waste liquid storing body is loaded into the loading portion when moved from the first position to the second position. When the waste liquid storing body is located at the second position, the third region is empty. The protector covers at least a portion of the third region when the waste liquid storing body is at the second position. A concern that foreign matter falls to the third region is therefore reduced. Since the third region is empty, the waste liquid storing body located at the second position is movable to the first position. When the waste liquid storing body is at the first position, the protector is retracted from the protection position. A concern that the detachment of the waste liquid storing body is hindered can therefore be reduced.
[15] In the recording apparatus according to [14] described above, the protector may be provided at the loading portion, and may be retracted with respect to the waste liquid storing body when the waste liquid storing body is at the first position.

According to the configuration described above, the protector is retracted with respect to the waste liquid storing body located at the first position. Therefore, even when the protector is provided at the loading portion, the waste liquid storing body can be readily positioned at the first position.
[16] In the recording apparatus according to [15] described above, the waste liquid storing body may have a first side surface at which the insertion port is located, and a second side surface opposite the first side surface in the loading direction, the loading portion may have a wall portion facing the second side surface of the waste liquid storing body located at the second position, and the protector may be provided to be pivotable around a pivotal shaft extending in a first direction along the wall portion.

According to the configuration described above, the waste liquid storing body has the second side surface opposite the insertion port. The loading portion has the wall portion, which faces the second side surface. When the waste liquid storing body is at the second position, the third region is located between the second side surface and the wall portion. The protector is pivotable around the pivotal shaft provided along the wall portion. The size of the protector can therefore be reduced as compared with a case where the pivotal shaft is provided on the side facing the first side surface.
[17] In the recording apparatus according to [16] described above, a first length from the pivotal shaft to a tip of the protector may be longer than a second length of the third region in the loading direction.

According to the configuration described above, the first length of the protector is longer than the second length of the third region. Therefore, creation of a gap between the protector and the waste liquid storing body can be avoided, so that fall of foreign matter to the third region can be more effectively avoided.
[18] The recording apparatus according to [17] described above may further include a cover portion configured to cover the discharger from above, and when the waste liquid storing body is at the second position, a third length over which the cover portion and the waste liquid storing body overlap with each other in the loading direction may be shorter than the first length and the second length.

According to the configuration described above, the cover portion covers the discharger from above. A concern that the user touches the discharger can therefore be reduced. The third length, over which the waste liquid storing body at the second position overlaps with the cover portion, is shorter than the first length of the protector and the second length of the third region. The thus set lengths can prevent the waste liquid storing body at the first position from overlapping with the cover portion in the loading direction.
[19] In the recording apparatus according to [15] described above, the loading portion may include a slide portion movable in the loading direction, the protector may be provided at the slide portion, and the slide portion may engage with the waste liquid storing body and move in the loading direction along with the waste liquid storing body.

According to the configuration described above, the protector is provided at the slide portion. The slide portion moves along with the waste liquid storing body. The protector can therefore be readily displaced in conjunction with the movement of the waste liquid storing body.
[20] In the recording apparatus according to [19] described above, the waste liquid storing body may have a first side surface at which the insertion port is located, and a second side surface opposite the first side surface in the loading direction, the loading portion may have a wall portion facing the second side surface of the waste liquid storing body located at the second position, and the protector may be a sheet member having one end attached to the slide portion and another end movable along the wall portion.

According to the configuration described above, the protector is a sheet member. One end of the protector is attached to the slide portion, and the other end thereof is movable. Therefore, when the slide portion moves along with the waste liquid storing body, the protector is pulled out and can cover the third region.
[21] The recording apparatus according to any one of [15] to [19] described above may include an urging member configured to urge the protector toward the protection position.

According to the configuration described above, the urging member urges the protector toward the protection position. That is, for example, when the waste liquid storing body is moved from the first position to the second position, the protector can be displaced to the protection position in conjunction with the movement of the waste liquid storing body. The waste liquid storing body can therefore be readily loaded into the loading portion.
[22] The recording apparatus according to any one of [14] to [21] described above may further include the waste liquid storing body, the waste liquid storing body may include a main body configured to store the waste liquid, the protector may be provided at the main body and may be displaceable to an overhanging position where the protector overhangs from the main body and a stored position where an amount of overhang with respect to the main body is smaller the amount of overhang at the overhanging position, and the overhanging position may coincide with the protection position when the waste liquid storing body is at the second position.

For example, when the protector is provided at the loading portion, to position the waste liquid storing body at the first position from outside, the protector may have to be retracted. In this regard, according to the configuration described above, the protector is provided at the waste liquid storing body. A concern that the protector hinders the attachment of the waste liquid storing body can therefore be reduced.
[23] In the recording apparatus according to [22] described above, the protector may be displaceable to the overhanging position and the stored position when pivoting around a pivotal shaft extending in a first direction.

According to the configuration described above, the protector is pivotable around the pivotal shaft extending in the first direction.

Causing the protector to pivot allows the protector to be readily displaced to the stored position and the overhanging position.
[24] In the recording apparatus according to [23] described above, the waste liquid storing body may include an urging member configured to urge the protector located at the stored position toward the overhanging position, and a restricting portion configured to restrict displacement of the protector located at the stored position, and the restricting portion may be configured to release the restriction of the protector in a process of displacing the waste liquid storing body from the first position to the second position.

According to the configuration described above, when the waste liquid storing body is displaced from the first position to the second position, the restricting portion releases the restriction of the protector. That is, the protector is pivotable around the pivotal shaft. The protector located at the stored position is urged by the urging member toward the overhanging position. The protector can therefore be displaced to the overhanging position in conjunction with the displacement of the waste liquid storing body.
[25] In the recording apparatus according to [22] described above, the protector may be displaceable to the overhanging position and the stored position when sliding with respect to the main body.

According to the configuration described above, the protector is slidable with respect to the main body. A space necessary for displacing the protector with respect to the main body can therefore be reduced.
[26] In the recording apparatus according to [25] described above, the loading portion may include an interference portion, when the waste liquid storing body is located at the first position, the protector may be located at the stored position, the interference portion may interfere with the protector in a process of displacing the waste liquid storing body from the first position to the second position in the loading direction, and the protector may be displaced to the overhanging position by moving the protector with respect to the main body.

According to the configuration described above, the interference portion can interfere with the protector. The interference portion moves the protector with respect to the main body when interfering with the protector in the process of displacing the waste liquid storing body in the loading direction. The protector can therefore be displaced to the overhanging position in conjunction with the displacement of the waste liquid storing body.
[27] In the recording apparatus according to [25] or [26] described above, the waste liquid storing body may have a first side surface at which the insertion port is located, and a second side surface opposite the first side surface in the loading direction, the loading portion may have a wall portion facing the second side surface of the waste liquid storing body located at the second position, the protector may be located at the overhanging position when the waste liquid storing body is at the second position, the wall portion may interfere with the protector in a process of displacing the waste liquid storing body from the second position to the first position in a detachment direction opposite the loading direction, and the protector may be displaced to the stored position by moving the protector with respect to the main body.

According to the configuration described above, the wall portion can interfere with the protector. The wall portion moves the protector with respect to the main body when interfering with the protector in the process of displacing the waste liquid storing body in the detachment direction. The protector can therefore be displaced to the stored position in conjunction with the displacement of the waste liquid storing body.
[28] In the recording apparatus according to any one of [22] to [27] described above, an opening configured to facilitate evaporation of the waste liquid may be formed in the main body, the protector located at the stored position may cover at least a portion of the opening, and the protector located at the overhanging position may uncover at least a portion of the opening.

According to the configuration described above, the protector located at the overhanging position uncovers at least a portion of the opening, which can facilitate evaporation of the waste liquid. The protector located at the stored position covers at least a portion of the opening, which can reduce a concern that the waste liquid leaks via the opening.
[29] The recording apparatus according to any one of [14] to [28] described above may further include a cover configured to cover the loading portion.

According to the configuration described above, the cover covers the loading portion. Inadvertent access to the waste liquid storing body loaded into the loading portion can therefore be suppressed.
[30] In the recording apparatus according to [29] described above, the waste liquid storing body may have a first side surface at which the insertion port is located, a second side surface opposite the first side surface in the loading direction, and a third side surface that intersects with the second side surface, the loading portion may include a first contact portion configured to come into contact with the waste liquid storing body, the first contact portion may come into contact with the third side surface when the waste liquid storing body is at the first position, and the first contact portion may come into contact with the second side surface when the waste liquid storing body is at the second position.

According to the configuration described above, the first contact portion comes into contact with different surfaces of the waste liquid storing body in accordance with the position of the waste liquid storing body. For example, when the user displaces the waste liquid storing body located at the first position to the second position, the first contact portion comes into contact with a different surface, allowing the user to feel a click sensation. The user is thus notified that the waste liquid storing body has been displaced to the second position, so that failure of the operation of loading the waste liquid storing body can be suppressed.
[31] In the recording apparatus according to [30] described above, the loading portion may include a second contact portion configured to come into contact with the first side surface, and the second contact portion may push the first side surface in a detachment direction opposite the loading direction.

According to the configuration described above, the loading portion includes the second contact portion. The waste liquid storing body is pushed in the detachment direction when coming into contact with the second contact portion. The first contact portion having come into contact with the second side surface prevents the waste liquid storing body displaced to the second position from being displaced in the detachment direction. Therefore, even when the waste liquid storing body displaced to the second position is pushed by the second contact portion, the waste liquid storing body stays at the second position. However, when the user releases his/her hand from the waste liquid storing body before displacing the waste liquid storing body to the second position, the waste liquid storing body is displaced in the detachment direction. The user can therefore notice that the waste liquid storing body has not been loaded.
[32] The recording apparatus according to any one of [22] to [24] described above may further include a cover displaceable to a non-cover position where the cover does not close the loading portion and a cover position where the cover closes the loading portion, and when the waste liquid storing body is at an intermediate position between the first position and the second position, the cover moving from the non-cover position toward the cover position may interfere with the protector before moving to the cover position.

According to the configuration described above, in the state in which the waste liquid storing body is located at the intermediate position, the cover interferes with the protector and cannot therefore close the loading portion. The user can therefore notice that the waste liquid storing body has not been loaded.
[33] A waste liquid storing body is attachable to and detachable from a recording apparatus including a recording portion configured to perform recording by ejecting liquid onto a medium, the waste liquid storing body configured to store waste liquid discharged from the recording portion, and including: a main body at which an insertion port into which a discharger provided in the recording apparatus is inserted is formed, the main body configured to store the waste liquid; and a protector displaceable with respect to the main body, a region occupied by the waste liquid storing body located at a first position where the discharger is not inserted into the insertion port is called a first region, a region occupied by the waste liquid storing body located at a second position where the discharger is inserted into the insertion port is called a second region, a region that does not overlap with the second region out of the first region is called a third region, and when the waste liquid storing body is at the second position, the protector covers at least a portion of the third region. The configuration described above can provide the same advantages as those of the recording apparatus described above.
[34] A recording apparatus to and from which the waste liquid storing body according to [33] described above is attachable and detachable includes: the recording portion configured to perform recording by ejecting liquid onto a medium; the discharger inserted into the insertion port of the waste liquid storing body and configured to discharge the waste liquid into the waste liquid storing body; and a loading portion into which the waste liquid storing body is loaded when the waste liquid storing body is displaced in a loading direction from the first position, where the discharger is not inserted into the insertion port, to the second position, where the discharger is inserted into the insertion port. The configuration described above can provide the same advantages as those of the recording apparatus described above.

What is claimed is:

1. A recording apparatus comprising:
a recording portion configured to perform recording by ejecting liquid onto a medium, waste liquid discharged from the recording portion being stored in a waste liquid storing body;
a discharger inserted into an insertion port of the waste liquid storing body and configured to discharge the waste liquid into the waste liquid storing body;
a loading portion into which the waste liquid storing body is loaded when the waste liquid storing body is displaced in a loading direction from a first position where the discharger is not inserted into the insertion port toward a second position where the discharger is inserted into the insertion port; and
a displaceable protector,
wherein a region occupied by the waste liquid storing body located at the first position is called a first region, a region occupied by the waste liquid storing body located at the second position is called a second region, a region that does not overlap with the second region out of the first region is called a third region,
the protector is located at a protection position where the protector covers at least a portion of the third region when the waste liquid storing body is at the second position, and
the protector is retracted from the protection position when the waste liquid storing body is at the first position.

2. The recording apparatus according to claim 1, wherein
the protector is provided at the loading portion, and is retracted with respect to the waste liquid storing body when the waste liquid storing body is at the first position.

3. The recording apparatus according to claim 2, wherein
the waste liquid storing body has a first side surface at which the insertion port is located, and a second side surface opposite the first side surface in the loading direction,
the loading portion has a wall portion facing the second side surface of the waste liquid storing body located at the second position, and
the protector is provided to be pivotable around a pivotal shaft extending in a first direction along the wall portion.

4. The recording apparatus according to claim 3, wherein
a first length from the pivotal shaft to a tip of the protector is longer than a second length of the third region in the loading direction.

5. The recording apparatus according to claim 4 may further comprising
a cover portion configured to cover the discharger from above,
wherein when the waste liquid storing body is at the second position, a third length over which the cover portion and the waste liquid storing body overlap with each other in the loading direction is shorter than the first length and the second length.

6. The recording apparatus according to claim 2, wherein
the loading portion includes a slide portion movable in the loading direction,
the protector is provided at the slide portion, and
the slide portion engages with the waste liquid storing body and moves in the loading direction along with the waste liquid storing body.

7. The recording apparatus according to claim 6, wherein
the waste liquid storing body has a first side surface at which the insertion port is located, and a second side surface opposite the first side surface in the loading direction,
the loading portion has a wall portion facing the second side surface of the waste liquid storing body located at the second position, and
the protector is a sheet member having one end attached to the slide portion and another end movable along the wall portion.

8. The recording apparatus according to claim 2, further comprising
an urging member configured to urge the protector toward the protection position.

9. The recording apparatus according to claim 1, further comprising
the waste liquid storing body,
wherein the waste liquid storing body includes a main body configured to store the waste liquid,
the protector is provided at the main body and is displaceable to an overhanging position where the protector overhangs from the main body and a stored position where an amount of overhang with respect to the main body is smaller the amount of overhang at the overhanging position, and
the overhanging position coincides with the protection position when the waste liquid storing body is at the second position.

10. The recording apparatus according to claim 9, wherein
the protector is displaceable to the overhanging position and the stored position when pivoting around a pivotal shaft extending in a first direction.

11. The recording apparatus according to claim 10, wherein
the waste liquid storing body includes
an urging member configured to urge the protector located at the stored position toward the overhanging position, and
a restricting portion configured to restrict displacement of the protector located at the stored position, and
the restricting portion is configured to release the restriction of the protector in a process of displacing the waste liquid storing body from the first position to the second position.

12. The recording apparatus according to claim 9, wherein
the protector is displaceable to the overhanging position and the stored position when sliding with respect to the main body.

13. The recording apparatus according to claim 12, wherein
the loading portion includes an interference portion,
when the waste liquid storing body is located at the first position, the protector is located at the stored position, and
the interference portion interferes with the protector in a process of displacing the waste liquid storing body from the first position to the second position in the loading direction, and
the protector is displaced to the overhanging position by moving the protector with respect to the main body.

14. The recording apparatus according to claim 13, wherein
the waste liquid storing body has a first side surface at which the insertion port is located, and a second side surface opposite the first side surface in the loading direction,
the loading portion has a wall portion facing the second side surface of the waste liquid storing body located at the second position,
the protector is located at the overhanging position when the waste liquid storing body is at the second position,
the wall portion interferes with the protector in a process of displacing the waste liquid storing body from the second position to the first position in a detachment direction opposite the loading direction, and
the protector is displaced to the stored position by moving the protector with respect to the main body.

15. The recording apparatus according to claim 9, wherein
an opening configured to facilitate evaporation of the waste liquid is formed in the main body,
the protector located at the stored position covers at least a portion of the opening, and
the protector located at the overhanging position uncovers at least a portion of the opening.

16. The recording apparatus according to claim 1, further comprising
a cover configured to cover the loading portion.

17. The recording apparatus according to claim 16, wherein
the waste liquid storing body has a first side surface at which the insertion port is located, a second side surface opposite the first side surface in the loading direction, and a third side surface that intersects with the second side surface,
the loading portion includes a first contact portion configured to come into contact with the waste liquid storing body,
the first contact portion comes into contact with the third side surface when the waste liquid storing body is at the first position, and
the first contact portion comes into contact with the second side surface when the waste liquid storing body is at the second position.

18. The recording apparatus according to claim 9, further comprising
a cover displaceable to a non-cover position where the cover does not close the loading portion and a cover position where the cover closes the loading portion, and
when the waste liquid storing body is at an intermediate position between the first position and the second position, the cover moving from the non-cover position toward the cover position interferes with the protector before moving to the cover position.

19. A waste liquid storing body attachable to and detachable from a recording apparatus including a recording portion configured to perform recording by ejecting liquid onto a medium, the waste liquid storing body configured to store waste liquid discharged from the recording portion, the waste liquid storing body comprising:
a main body at which an insertion port into which a discharger provided in the recording apparatus is inserted is formed, the main body configured to store the waste liquid; and
a protector displaceable with respect to the main body,
wherein a region occupied by the waste liquid storing body located at a first position where the discharger is not inserted into the insertion port is called a first region, a region occupied by the waste liquid storing body located at a second position where the discharger is inserted into the insertion port is called a second region, a region that does not overlap with the second region out of the first region is called a third region, and
when the waste liquid storing body is at the second position, the protector covers at least a portion of the third region.

20. A recording apparatus to and from which the waste liquid storing body according to claim 19 is attachable and detachable, the recording apparatus comprising:
the recording portion configured to perform recording by ejecting liquid onto a medium;
the discharger inserted into the insertion port of the waste liquid storing body and configured to discharge the waste liquid into the waste liquid storing body; and
a loading portion into which the waste liquid storing body is loaded when the waste liquid storing body is displaced in a loading direction from the first position, where the discharger is not inserted into the insertion port, toward the second position, where the discharger is inserted into the insertion port.
